(19) United States
(12) Patent Application Publication
(10) Pub. No.: US 2024/0397522 A1
(43) Pub. Date: Nov. 28, 2024

(54) TERMINAL AND WIRELESS COMMUNICATION METHOD

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/690,940

(22) PCT Filed: Sep. 16, 2021
(86) PCT No.: PCT/JP2021/034183

§ 371 Date: Mar. 11, 2024

(51) Int. Cl. H04W 72/231; H04L 1/1812; H04W 72/21

(52) U.S. Cl. CPC H04W 72/231; H04L 1/1812; H04W 72/21

(57) ABSTRACT

This terminal comprises a receiving unit which receives a downstream control signal, and a control unit which, on the basis of the downstream control signal, controls repeat transmission of an upstream control signal and delaying transmission of the upstream control signal.

### TECHNICAL FIELD

The present disclosure relates to a terminal and a radio communication method.

### BACKGROUND ART

Long Term Evolution (LTE) has been specified for achieving a higher data rate, lower latency, and the like in a Universal Mobile Telecommunication System (UMTS) network. Future systems of LTE have also been studied for achieving a broader bandwidth and a higher speed based on LTE. Examples of the LTE successor include, for example, systems called LTE-Advanced (LTE-A), Future Radio Access (FRA), 5th generation mobile communication system (5G), 5G plus (5G+), Radio Access Technology (New-RAT), New Radio (NR), and the like.

In NR, for example, enhancement of a feedback function from a terminal to a base station has been discussed in order to improve communication quality (e.g., see Non-Patent Literature (hereinafter, referred to as “NPL”) 1).

Information to be fed back from the terminal to the base station is transmitted in a resource of a Physical Uplink Control Channel (PUCCH). For enhancement of a ultra-reliable and low latency communication (URLLC) technology in Release 17 (hereinafter, sometimes referred to as Rel. 17 or Rel-17) of 3GPP, a method of configuring a resource for transmitting an uplink control signal including information to be fed back has been studied. Further, in Rel. 15 to Rel. 17 of 3GPP, it is agreed to support repetition (repetitive transmission) of PUCCH.

### CITATION LIST

### Non Patent Literature

### NPL 1

“Enhanced Industrial Internet of Things (IoT) and ultra-reliable and low latency communication,” RP-201310, 3GPP TSG RAN Meeting #86e, 3GPP, July, 2020

### SUMMARY OF INVENTION

There is room for further study on an operation of a terminal in a radio system capable of configuring a resource for transmitting an uplink control signal in consideration of repetition of the uplink control signal.

An aspect of the present disclosure is to provide a terminal that appropriately operates in a radio system capable of configuring a resource for transmitting an uplink control signal in consideration of repetition of the uplink control signal.

### Solution to Problem

A terminal according to an aspect of the present disclosure includes: a reception section that receives a downlink control signal; and a control section that controls, based on the downlink control signal, repetitive transmission of an uplink control signal and deferring of transmission of the uplink control signal.

A radio communication method according to an aspect of the present disclosure includes: receiving, by a terminal, a downlink control signal; and controlling, by the terminal, repetitive transmission of an uplink control signal and deferring of transmission of the uplink control signal based on the downlink control signal.

### BRIEF DESCRIPTION OF DRAWINGS

FIG. 1 is a diagram provided for describing an exemplary radio communication system according to an embodiment;

FIG. 2 illustrates an exemplary configuration of a radio communication system when dual connectivity (DC) is performed;

FIG. 3 illustrates an exemplary basic operation of the communication system according to the embodiment;

FIG. 4 illustrates exemplary SPS HARQ-ACK deferring;

FIG. 5 illustrates exemplary PUCCH repetition;

FIG. 6 illustrates an exemplary higher layer parameter indicating information on the number of PUCCH repetitions;

FIG. 7 illustrates exemplary PUCCH repetition postponing;

FIG. 8 illustrates exemplary sub-slot-based PUCCH repetition;

FIG. 9 illustrates cases exemplarily described in the embodiment;

FIG. 10 illustrates an example of Proposal 1 in Case 1-1;

FIG. 11 illustrates the first example of Proposal 1 in Case 1-1;

FIG. 12 illustrates the first example of Proposal 2 in Case 2;

FIG. 13 illustrates supplements to Option 2 of Proposal 2;

FIG. 14 is a block diagram illustrating an exemplary configuration of a base station according to the present embodiment;

FIG. 15 is a block diagram illustrating an exemplary configuration of a terminal according to the present embodiment; and

FIG. 16 illustrates an exemplary hardware configuration of the base station and the terminal according to the present embodiment.

### DESCRIPTION OF EMBODIMENTS

Hereinafter, an embodiment according to an aspect of the present disclosure will be described with reference to the drawings.

### Embodiment

NR defines semi-persistent scheduling (SPS) in which a resource of a Physical Downlink Shared Channel (PDSCH) is preconfigured in terminal 20 and activation/release is performed by Downlink Control Information (DCI). The SPS allows low-latency data reception.

When an uplink (UL) slot is mapped after a plurality of downlink (DL) slots continues, a terminal possibly transmits, in the UL slot after the DL slots, a confirmation response (e.g., Hybrid Automatic Repeat request—Acknowledgement (HARQ-ACK)) for reception of the plurality of data in the DL slots.

Note that, in the following description, a PDSCH based on SPS may be referred to as an SPS PDSCH, and the confirmation response for the SPS PDSCH may be referred to as an SPS HARQ-ACK.

The present embodiment exemplifies a radio communication system in which an operation by SPS is possible, an SPS PDSCH is transmitted from a base station to a terminal, and an uplink control signal (e.g., signal of a Physical Uplink Control Channel (PUCCH)) including an SPS HARQ ACK is transmitted from the terminal to the base station.

### (System Configuration)

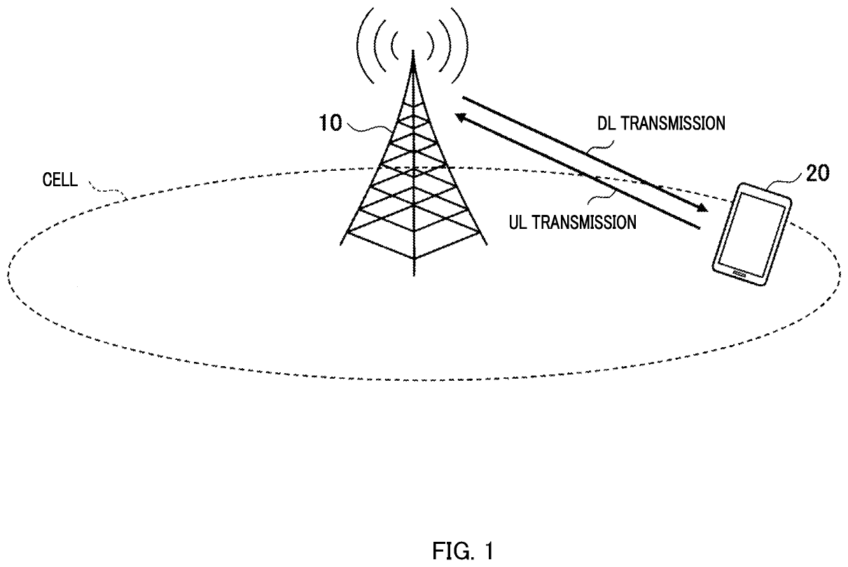

FIG. 1 is a diagram provided for describing an exemplary radio communication system according to an embodiment of the present disclosure. The radio communication system in the embodiment of the present disclosure includes base station 10 and terminal 20 as illustrated in FIG. 1. FIG. 1 illustrates one base station 10 and one terminal 20, but it is merely an example, and the numbers of base stations 10 and terminals 20 may each be plural.

Base station 10 is a communication apparatus that provides one or more cells and performs radio communication with terminal 20. A physical resource for a radio signal is defined by time domain and frequency domain. The time domain may be defined by the number of OFDM symbols, and the frequency domain may be defined by the number of subcarriers or the number of resource blocks. Further, a Transmission Time Interval (TTI) in time domain may be a slot or a subframe.

Base station 10 can perform carrier aggregation, in which communication with terminal 20 is performed by bundling a plurality of cells (e.g., a plurality of component carriers (CCs)) together. In the carrier aggregation, one PCell (primary cell) and one or more SCells (secondary cells) are used.

Base station 10 transmits a synchronization signal, system information, and the like to terminal 20. Examples of the synchronization signal include an NR-PSS and an NR-SSS. The system information is transmitted by, for example, an NR-PBCH or a PDSCH, and is also referred to as broadcast information. As illustrated in FIG. 1, base station 10 transmits a control signal or data to terminal 20 in DL and receives a control signal or data from terminal 20 in UL. Note that what is transmitted by a control channel such as a PUCCH or Physical Downlink Control Channel (PDCCH) is referred to as a control signal and what is transmitted by a shared channel such as a Physical Uplink Shared Channel (PUSCH) or PDSCH is referred to as data, but these names are merely examples.

Terminal 20 is a communication device having a radio communication function, such as a smart phone, a mobile phone, a tablet, a wearable terminal, a Machine-to-Machine (M2M) communication module. As illustrated in FIG. 1, terminal 20 receives a control signal or data from base station 10 in DL and transmits a control signal or data to base station in UL, so that terminal 20 uses various communication services provided by the radio communication system. Note that terminal 20 may be referred to as a UE, and base station may be referred to as a gNB.

Terminal 20 can perform carrier aggregation (CA), in which communication with base station 10 is performed by bundling a plurality of cells (a plurality of component carriers (CCs)) together. In the carrier aggregation, one PCell (primary cell) and one or more SCells (secondary cells) are used. Further, a PUCCH-SCell including a PUCCH may be used.

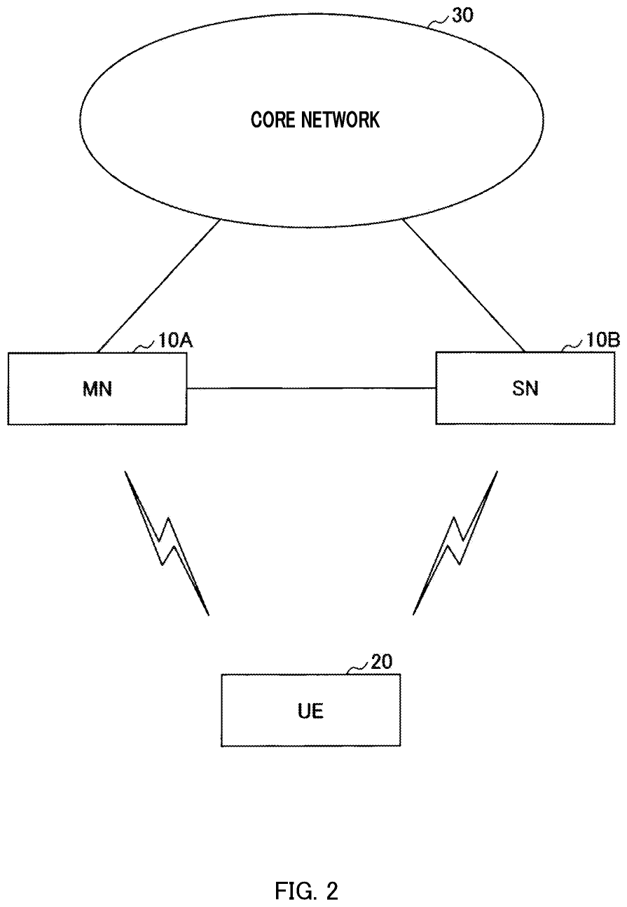

FIG. 2 illustrates an exemplary configuration of a radio communication system when dual connectivity (DC) is performed. As illustrated in FIG. 2, base station 10A serving as a master node (MN) and base station 10B serving as a secondary node (SN) are included. Base station 10A and base station 10B are each connected to a core network. Terminal 20 can communicate with both base station 10A and base station 10B.

A cell group provided by base station 10A, which is an MN, is referred to as a Master Cell Group (MCG), and a cell group provided by base station 10B, which is an SN, is referred to as a Secondary Cell Group (SCG). Further, in the DC, the MCG is constituted by one PCell and one or more SCells, and the SCG is constituted by one Primary SCell (PSCell) and one or more SCells.

The processing operation in the present embodiment may be executed in the system configuration illustrated in FIG. 1, in the system configuration illustrated in FIG. 2, or in a system configuration other than the above.

### Exemplary Basic Operation

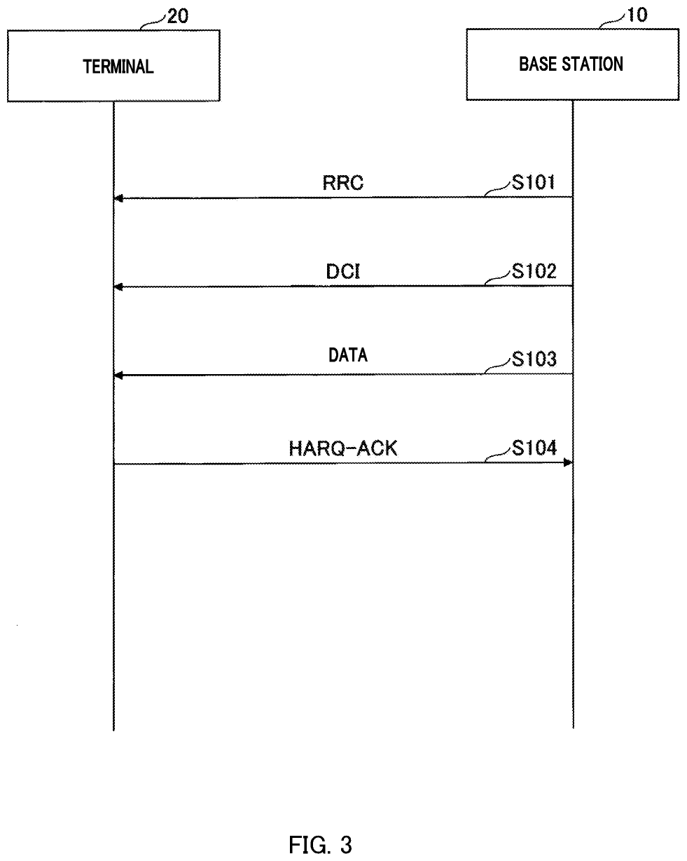

An exemplary basic operation of the communication system according to the embodiment of the present disclosure will be described with reference to FIG. 3.

In S101, base station 10 transmits configuration information on downlink SPS, configuration information on a PUCCH resource, configuration information on a slot format, and/or the like to terminal 20 by radio resource control (RRC) signaling, and terminal 20 receives these pieces of configuration information. Note that the present embodiment is for downlink SPS, and thus the term “SPS” means downlink SPS in the following description.

The configuration information on a slot format is, for example, tdd-UL-DL-ConfigurationCommon or tdd-UL-DL-ConfigurationDedicated, and this configuration information configures whether a time division duplex (TDD) configuration in each symbol in each slot for one or more slots to be DL, UL, or flexible. Hereinafter, this configuration information is referred to as semi-static TDD configuration information. Further, the term “flexible” is sometimes represented as “F.” Terminal 20 basically determines DL/UL/F of each symbol in each slot in accordance with the semi-static TDD configuration information.

Further, as configuration information in S101, a plurality of candidates for the slot format in order to allow dynamic switching of slot formats may be indicated. This configuration information is, for example, SlotFormatCombinationsPerCell. This information is information consisting of IDs of slot formats (SFs), and thus is referred to as SFI configuration information in the following description.

Terminal 20 receives DCI that activates the configuration of SPS, from base station in S102, and receives data in a PDSCH resource with an SPS configuration in S103. In S104, terminal 20 transmits an SPS HARQ-ACK to base station 10 in a PUCCH resource (may be a PUSCH resource when UL scheduling is performed) in a slot at a time position specified by the DCI. Note that the SPS HARQ-ACK is sometimes referred to as a HARQ-ACK. Further, the HARQ-ACK may be referred to as HARQ information, feedback information, or the like.

Terminal 20 receives, from base station 10, DCI that dynamically specifies a slot format in S102 or before/after S102 in some cases. This DCI is control information that specifies an ID to be actually used among IDs of a plurality of slot formats configured by the SFI configuration information. When a slot format is specified by this DCI, terminal 20 determines DL/UL/F of each symbol in each slot in accordance with the slot format instead of the semi-static TDD configuration information. Information of this DCI is referred to as dynamic SFI specification information (or dynamic SFI or SFI).

In a case where SPS is configured, a symbol position where a PUCCH resource is configured possibly overlaps with another symbol (e.g., semi-static DL symbol) depending on a DL/UL configuration of TDD (configuration by semi-static TDD configuration information or dynamic SFI specification information) in a slot at a specified time position, and a HARQ-ACK may be incapable of being transmitted.

3GPP has been discussing technologies for a system called URLLC and Industrial Internet of Things (IIoT) in Rel. 17. For URLLC, enhancement of a feedback function of a terminal for a Hybrid Automatic Repeat request-Acknowledgement (HARQ-ACK) has been studied. The HARQ-ACK is an example of information on a confirmation response (e.g., acknowledgement) to data received by the terminal. As an example of the functional enhancement against the above-described overlapping, deferral of the above-described SPS HARQ-ACK (SPS HARQ-ACK deferring) has been discussed.

### <SPS HARQ-ACK Deferring>

In 3GPP, it is agreed to support SPS HARQ-ACK deferring in Rel-17. 3GPP also agrees on the following points regarding the SPS HARQ-ACK deferring.

An SPS HARQ-ACK PUCCH may be deferred when a PUCCH using “SPS-PUCCH-AN-List-r16” or “n1PUCCH-AN” overlaps with a semi-static DL or an SSB symbol. Note that the SSB is an abbreviation for an SS/PBCH block, and the SS is an abbreviation for a Synchronization Signal, and the PBCH is an abbreviation for a Physical Broadcast Channel and may be referred to as a broadcast channel.

Note that the “SPS-PUCCH-AN-List-r16” is included in information (e.g., PUCCH-Config) for configuring a parameter of a PUCCH resource for a terminal. The “SPS-PUCCH-AN-List-r16” is exemplary information indicating a list of PUCCH resources for DL SPS HARQ-ACKs. Further, the “n1PUCCH-AN” is included in information (e.g., SPS-Config) used for configuring semi-persistent DL transmission, for example. The “n1PUCCH-AN” is exemplary information indicating a PUCCH HARQ resource for DL SPS.

The SPS HARQ-ACK deferring may be configured for each SPS configuration. A HARQ-ACK with an SPS PDSCH configuration for which deferring is possible can be deferred.

A maximum deferral limitation may be configured for each SPS configuration. For example, a condition that “K1_max_def=K1+K_def” does not exceed a limitation (e.g., maximum deferral limitation) may be provided. Note that the K1 indicates an offset from a slot of data (e.g., SPS PDSCH) to a slot of a confirmation response (e.g., SPS HARQ-ACK) for the data. The K_def indicates an offset from a slot indicated by K1 to a slot of a HARQ-ACK to be deferred.

A slot in which the deferred SPS HARQ-ACK may be transmitted is referred to as a target slot or a target PUCCH slot.

For example, the target slot is a first available slot in which the determined PUCCH resource does not overlap with a disabled symbol (e.g., semi-static DL or SSB symbol). The determined PUCCH resource may correspond to, for example, a PUCCH resource used for transmission of the deferred SPS HARQ-ACK. Further, the first available slot may be the earliest slot in the time direction. Further, the disabled symbol may be a symbol different from the semi-static DL or the SSB symbol.

For determination of the target slot, multiplexing of an SPS HARQ-ACK and a dynamic HARQ-ACK may be considered.

When the deferred SPS HARQ-ACK is not transmitted after the determination of the targeted PUCCH slot, transmission of the deferred SPS HARQ-ACK bit may need not be further deferred. In this case, the deferred SPS HARQ-ACK bit may be dropped.

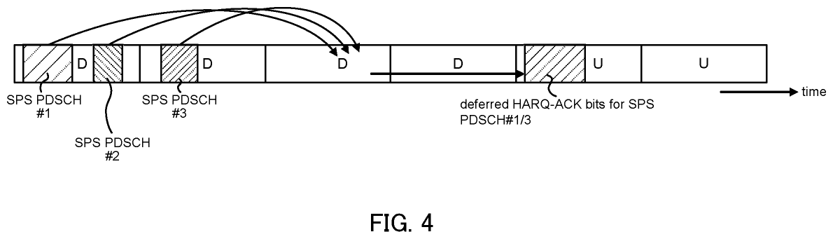

FIG. 4 illustrates exemplary SPS HARQ-ACK deferring. The horizontal axis in FIG. 4 represents a time axis. FIG. 4 exemplarily illustrates six slots. Note that, in the following description, the plurality of slots may each be referred to as a first slot, a second slot, and so on in order from the oldest (the left side in the drawing). The six slots are each labeled “D” or “U.” Slots labeled “D” indicate DL slots, and slots labeled “U” indicate UL slots. The first slot includes SPS PDSCH #1 and SPS PDSCH #2, and the second slot includes SPS PDSCH #3.

A case is herein exemplarily described where SPS HARQ-ACK deferring is enabled for SPS configurations of SPS PDSCH #1 and SPS PDSCH #3 and is disabled for an SPS configuration of SPS PDSCH #2, and SPS HARQ-ACKs for respective SPS PDSCHs may be transmitted in the third slot. The phrase “SPS HARQ-ACKs for respective SPS PDSCHs may be transmitted in the third slot” may correspond to that information indicating slots of transmitting SPS HARQ-ACKs indicates transmission in the third slot. In this case, the SPS HARQ-ACKs overlap with a semi-static DL in the third slot, and thus the SPS HARQ-ACK PUCCH is deferred.

A slot in which an SPS HARQ-ACK for an SPS PDSCH may be transmitted (third slot in FIG. 4) is specified by a parameter “K1.” The K1 indicates an offset from data (e.g., SPS PDSCH) to the corresponding confirmation response (e.g., SPS HARQ-ACK). In FIG. 4, K1=2 is set for SPS PDSCH #1, and K1=1 is set for SPS PDSCH #2, so that the third slot is indicated.

In the example in FIG. 4, the fifth slot corresponds to the first available slot (target slot) that does not overlap with a disabled symbol (e.g., semi-static DL or SSB symbol). Thus, HARQ-ACK bits (deferred HARQ-ACK bits) for SPS PDSCH #1 and SPS PDSCH #3 for which SPS HARQ-ACK deferring is enabled are transmitted in the target slot.

### <Slot-Based PUCCH Repetition>

Slot-based PUCCH repetition is supported for PUCCH formats 1/3/4 of Rel.15/16. For example, a terminal repeatedly transmits a PUCCH predetermined times based on an indication from and/or configuration by a base station.

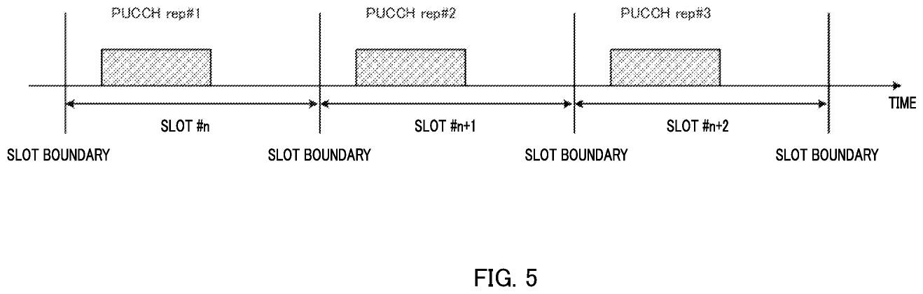

FIG. 5 illustrates exemplary PUCCH repetition. The number of PUCCH repetitions may be determined based on information indicated from a base station. The n-th repetition may also be referred to as the n-th transmission occasion or the like. For example, the first transmission may be referred to as the first PUCCH repetition.

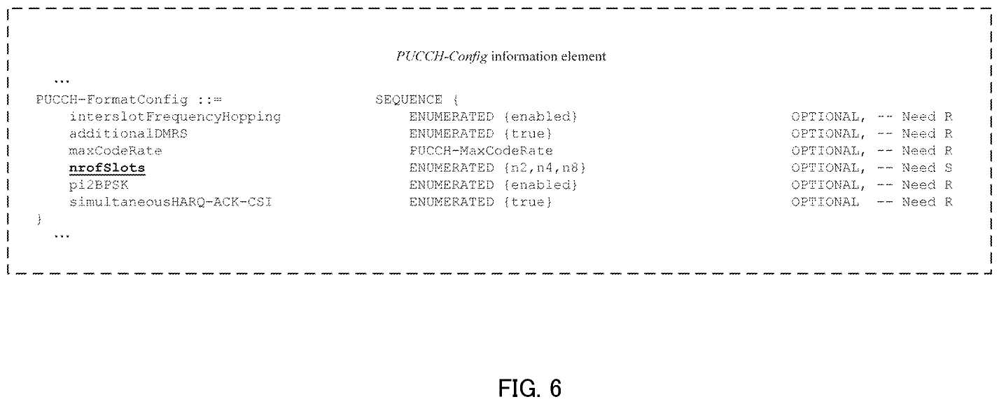

FIG. 6 illustrates an exemplary higher layer parameter indicating information on the number of PUCCH repetitions. A terminal may receive information indicating the number of repetitions by, for example, a higher layer parameter such as RRC.

For example, as illustrated in FIG. 6, the terminal may receive information indicating the number of PUCCH repetitions by a number-of-slots information element nrofSlots. The number-of-slots information element nrofSlots may be configured for each PUCCH resource. The same symbol allocation may be applied to n consecutive slots.

For the terminal, the number of PUCCH repetitions N_PUCCH\hat{ }repeat (may be referred to as N_{PUCCH}^{repeat}) for PUCCH repetition can be configured for PUCCH format 1, 3, or 4 by corresponding number-of-slots information elements nrofSlots.

The terminal follows Rules 1-1 to 1-3 to be described below in a case of N_PUCCH\hat{ }repeat>1.

### [Rule 1-1]

The terminal repeats PUCCH transmission including Uplink Control Information (UCI) over N_PUCCH\hat{ }repeat slots.

### [Rule 1-2]

PUCCH transmission in each of N_PUCCH\hat{ }repeat slots includes the same number of consecutive symbols. The number of symbols is provided by a number-of-slots information element nrofsymbols in a PUCCH format 1 information element PUCCH-format1, a number-of-slots information element nrofsymbols in a PUCCH format 3 information element PUCCH-format3, or a number-of-slots information element nrofsymbols in a PUCCH format 4 information element PUCCH-format4.

### [Rule 1-3]

PUCCH transmission in each of the N_PUCCH\hat{ }repeat slots includes the same first symbol (initial symbol index). The first symbol is provided by an initial symbol index information element startingSymbolIndex in a PUCCH formart 1 information element PUCCH-format1, an initial symbol index information element startingSymbolIndex in a PUCCH formart 3 information element PUCCH-format3, an initial symbol index information element startingSymbolIndex in a PUCCH formart 4 information element PUCCH-format4.

### <PUCCH Repetition Postponing>

In Release 16 (hereinafter, sometimes referred to as Rel.16 or Rel-16) of 3GPP, for example, in TS 38.213 section 9.2.6, collision of a PUCCH for which repetition is more than 1 is defined. The collision may be referred to as “direction collision.” Note that the collision may be read as overlapping.

For example, when the terminal determines that the number of symbols available for PUCCCH transmission for PUCCH transmission in a certain slot is smaller than a value given by “nrofSymbols” of the corresponding PUCCH format, the terminal need not transmit the PUCCH in the slot. In other words, in this case, the terminal determines that there is a collision of a PUCCH for PUCCH repetition in a certain slot.

Then, for the operation of PUCCH repetition postponing, the following is defined.

When PUCCH repetition collides with an SSB symbol or a symbol indicated as DL, PUCCH repetition in a case of N_{PUCCH}^{repeat}>1 may be postponed to the next available slot. Note that PUCCH repetition to be postponed may include the first PUCCH repetition. Further, the symbol indicated as DL may be a symbol indicated as DL by “tdd-UL-DL-ConfigurationCommon” or “tdd-UL-DL-ConfigurationDedicated.” Note that the “tdd-UL-DL-ConfigurationCommon” or “tdd-UL-DL-ConfigurationDedicated” is configuration information on a slot format and may be indicated (configured) by higher layer signaling (e.g., RRC signaling).

Note that, when the PUCCH is triggered by DCI, PUCCH repetition postponing for the first repetition in the above case may be supported or need not be supported.

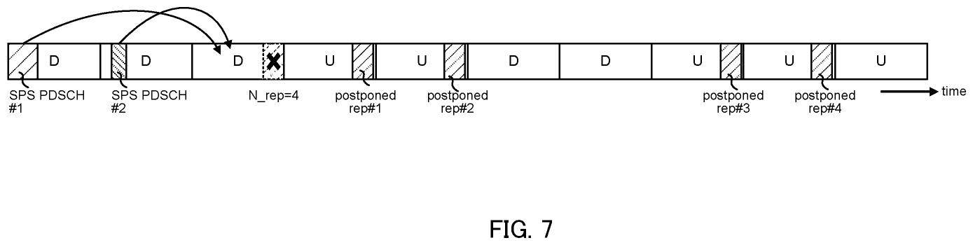

FIG. 7 illustrates exemplary PUCCH repetition postponing. FIG. 7 illustrates ten slots. Note that, as in FIG. 4, the letter “D” of each slot indicates a DL slot, and the letter “U” indicates a UL slot in FIG. 7.

The first slot in FIG. 7 includes SPS PDSCH #1, and the second slot includes SPS PDSCH #2.

A case will be exemplarily described herein where N_rep=4 and SPS HARQ-ACKs for respective SPS PDSCHs may be transmitted in the third slot by repetition, for example, K1 specifies the third slot. In this case, the SPS HARQ-ACKs overlap with a semi-static DL in the third slot. Thus, a PUCCH repetition for transmitting the SPS HARQ-ACKs is postponed.

In FIG. 7, the PUCCH repetition is transmitted not in the third slot but in a UL slot of or after the fourth slot. For example, the postponed first PUCCH repetition (“postponed rep #1” in FIG. 7) is transmitted in the fourth slot, and the postponed second, third, and fourth PUCCH repetitions (“postponed rep #2,” “postponed rep #3,” and “postponed rep #4” in FIG. 4) are respectively transmitted in the fifth, eighth, and ninth slots.

### <Sub-Slot-Based PUCCH Repetition>

In Rel.17, it is agreed to support sub-slot-based PUCCH repetition.

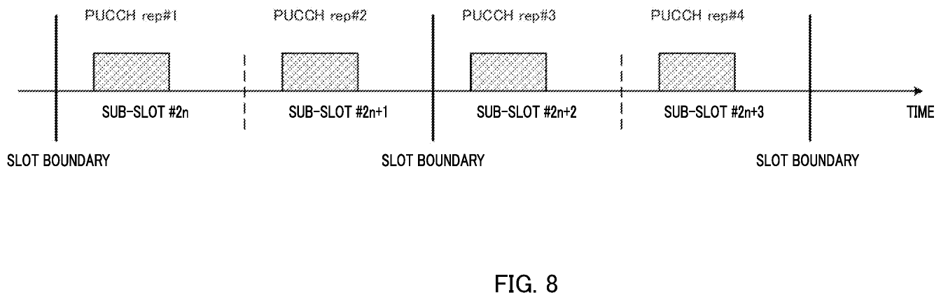

FIG. 8 illustrates exemplary sub-slot-based PUCCH repetition. FIG. 8 illustrates exemplary sub-slot-based PUCCH repetition in a case where a sub-slot length is set to seven symbols (e.g., subslotLengthForPUCCH=7) and the number of repetitions is set to four (e.g., nrofSlots/nrofsubslots=4). For example, the terminal controls PUCCH transmission so that PUCCH transmission is performed in each sub-slot (seven symbols).

In Rel. 17, it is agreed to apply a slot-based PUCCH procedure of Rel. 16 to a sub-slot-based PUCCH and to support sub-slot-based PUCCH repetition for HARQ-ACKs. That is, Rel. 17 adopts slot-based PUCCH of Rel. 16 by appropriately replacing a slot with a “sub-slot” without optimizing it except as required. Note that a dynamic repetition indicator is also supported for a sub-slot-based PUCCH of Rel. 17.

Further, for the sub-slot-based PUCCH repetition, it is also agreed to support PUCCH repetition in PUCCH formats 0 and 2.

### <Analysis>

As described above, PUCCH repetition postponing is supported for a PUCCH of N_{PUCCH}^{repeat}>1 in Rel-16. Further, introduction of SPS HARQ ACK deferring has been studied in Rel-17. There is room for further study on an operation in which PUCCH repetition postponing and SPS HARQ ACK deferring are combined and/or interaction between the PUCCH repetition postponing and the SPS HARQ ACK deferring.

For example, the operation in which PUCCH repetition postponing and SPS HARQ ACK deferring are combined and/or the interaction between the PUCCH repetition postponing and the SPS HARQ ACK deferring are considered in the following Cases 1 and 2.

Case 1:

Case 1 is a case of a HARQ-ACK PUCCH determined in an initial slot in which an initial SPS HARQ-ACK bit is included and a deferred SPS HARQ-ACK bit is not included, and where N_{PUCCH}^{repeat}>1 is determined for the PUCCH.

Case 1 includes the following Cases 1-1 and 1-2.

Case 1-1:

A case where a PUCCH resource in an initial slot (e.g., first PUCCH repetition) overlaps with a semi-static DL or an SSB symbol.

Case 1-2:

A case where a PUCCH resource in an initial slot (e.g., the first PUCCH repetition) does not overlap with a semi-static DL and an SSB symbol, and any one or more of PUCCH repetitions other than the first PUCCH repetition overlap with a semi-static DL or an SSB symbol. The PUCCH repetitions other than the first PUCCH repetition are, for example, PUCCH repetitions after the first PUCCH repetition.

Case 2:

Case 2 is a case of a HARQ-ACK PUCCH including a deferred SPS HARQ-ACK bit and where N_{PUCCH}^{repeat}>1 is determined for the PUCCH in a target slot.

Above-described Cases 1-1, 1-2, and 2 will be described with reference to the drawings.

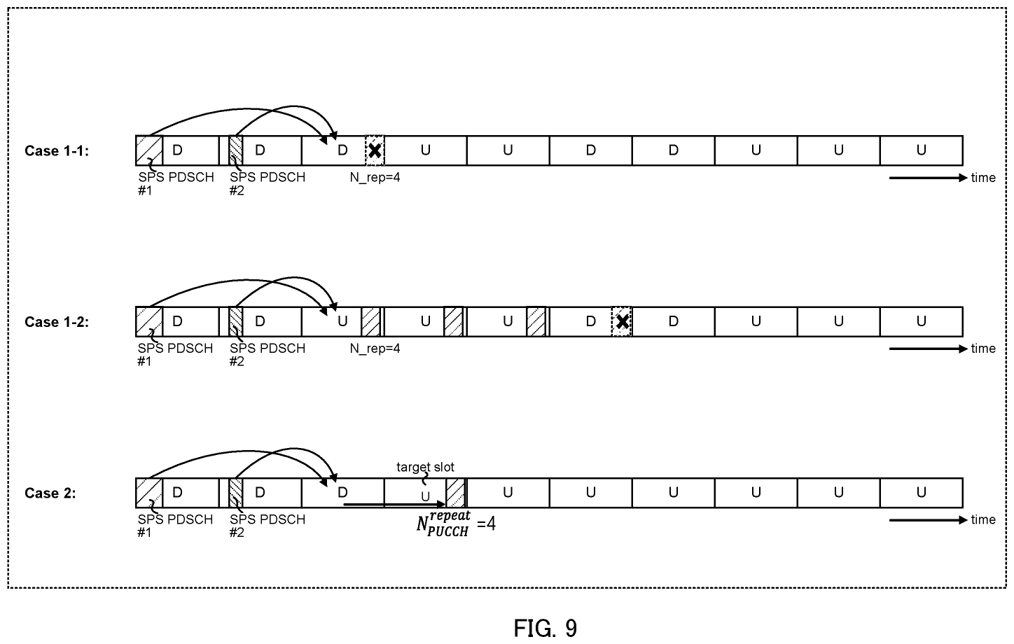

FIG. 9 illustrates cases exemplarily described in the present embodiment. FIG. 9 illustrates three cases: Cases 1-1, 1-2, and 2. For each case, ten slots are illustrated as in FIG. 7. Note that, as in FIG. 4, the letter “D” of each slot indicates a DL slot, and the letter “U” indicates a UL slot in FIG. 9.

Further, in each case, the first slot includes SPS PDSCH #1, and the second slot includes SPS PDSCH #2.

As in FIG. 7, a case will be exemplarily described where N_rep=4 and SPS HARQ-ACKs for respective SPS PDSCHs may be transmitted in the third slot by repetition.

Case 1-1 in FIG. 9 is a case where a PUCCH resource (e.g., the first PUCCH repetition) in the third slot, which is an initial slot, overlaps with a semi-static DL.

Case 1-2 in FIG. 9 is a case where a PUCCH resource (e.g., the first PUCCH repetition) in the third slot, which is an initial slot, does not overlap with a semi-static DL or an SSB symbol, and the fourth PUCCH repetition in the sixth slot overlaps with a semi-static DL.

In Case 2 in FIG. 9, SPS HARQ-ACKs for SPS PDSCH #1 and SPS PDSCH #2 overlap with a semi-static DL in the third slot, and thus the SPS HARQ-ACK PUCCH is deferred. Then, the HARQ-ACK PUCCH is present in the fourth slot, which is the target slot, and includes the deferred SPS-HARQ-ACK bit. Further, N_{PUCCH}^{repeat}>1 is determined for the PUCCH in the fourth slot.

For Cases 1-1, 1-2 and 2 described above, following considerations arise.

For Case 1-1, there is room for further study on whether the terminal should apply PUCCH repetition postponing in accordance with the rule of Rel-16 or to apply deferring of an SPS HARQ-ACK bit in accordance with the rule of SPS HARQ-ACK deferring of Rel. 17.

For Case 1-2, there is room for further study on whether to change the PUCCH repetition operation that follows the rule of Rel-16 for PUCCH repetition that collides with a disabled symbol (e.g., semi-static DL or SSB symbol).

For Case 2, there is room for further study on whether to apply the rule on determination of PUCCH repetition following the rule of Rel-16 or to specify another behavior, for a PUCCH in a target slot including a deferred SPS HARQ-ACK bit.

All of the above considerations relate to an operation in which PUCCH repetition postponing and SPS HARQ ACK deferring are combined and/or interaction between the PUCCH repetition postponing and the SPS HARQ ACK deferring. For these considerations, the present embodiment describes the following three proposals.

### Proposal 0

In Proposal 0, PUCCH repetition and SPS HARQ-ACK deferring is not assumed to be enabled at the same time. Alternatively, PUCCH repetition and SPS HARQ-ACK deferring are not assumed to be configured at the same time. For example, the terminal and/or the base station do not assume that PUCCH repetition and SPS HARQ-ACK deferring are enabled at the same time. Alternatively, the terminal and/or the base station do not assume that PUCCH repetition and SPS HARQ-ACK deferring are configured at the same time. The term “enabled” herein corresponds to “enable.” Note that, in Proposal 0, the PUCCH repetition and the SPS HARQ-ACK deferring are assumed to be configured at the same time, but need not be assumed to be enabled at the same time.

Note that, instead of Proposal 0, PUCCH repetition postponing and SPS HARQ-ACK deferring need not be assumed to be enabled at the same time. Alternatively, PUCCH repetition postponing and SPS HARQ-ACK deferring need not be assumed to be configured at the same time.

Further, PUCCH repetition and SPS HARQ-ACK deferring may be assumed to be enabled at the same time. Alternatively, PUCCH repetition and SPS HARQ-ACK deferring may be assumed to be configured at the same time. The terminal and/or the base station may assume that PUCCH repetition and SPS HARQ-ACK deferring are enabled at the same time. Alternatively, the terminal and/or the base station may assume that PUCCH repetition and SPS HARQ-ACK deferring are configured at the same time. In this case, for example, the following two proposals are considered for Cases 1 and 2.

### Proposal 1

In Proposal 1, PUCCH repetition and SPS HARQ-ACK deferring are assumed to be enabled at the same time in above-described Case 1 (Case 1-1 and Case 1-2). Alternatively, PUCCH repetition and SPS HARQ-ACK deferring are assumed to be configured at the same time.

### Proposal 2

In Proposal 2, PUCCH repetition and SPS HARQ-ACK deferring are assumed to be enabled at the same time in above-described Case 2. Alternatively, PUCCH repetition and SPS HARQ-ACK deferring are assumed to be configured at the same time.

Note that, in Proposals 1 and 2, PUCCH repetition postponing and SPS HARQ-ACK deferring may be assumed to be enabled at the same time. Alternatively, PUCCH repetition postponing and SPS HARQ-ACK deferring may be assumed to be configured at the same time.

In the following description, variations (option (sometimes abbreviated as “Opt.”) and/or alternations (sometimes abbreviated as “Alt.”) of each proposal will be described.

### Variations of Proposal 0

As described above, in Proposal 0, PUCCH repetition and SPS HARQ-ACK deferring are not assumed to be enabled or configured at the same time. Proposal 0 includes the following Proposal 0-1 and/or Proposal 0-2.

### Proposal 0-1

In Proposal 0-1, in any of the following cases of Alt. 1 to Alt. 5, the terminal does not assume that a PUCCH resource with the corresponding N_{PUCCH}^{repeat}>1 is selected. In other words, in any of the following cases of Alt. 1 to Alt. 5, the terminal does not assume that PUCCH repetition is enabled. Note that the phrase “in any of the following cases of Alt. 1 to Alt. 5” may correspond to a case where SPS HARQ-ACK deferring is enabled (or configured), a case where SPS HARQ-ACK deferring may be enabled, and a case where SPS HARQ-ACK deferring is assumed to be enabled (or configured).

Alt. 1: The PUCCH includes an SPS HARQ-ACK with an SPS configuration in which deferring is enabled. Note that, in this case, the PUCCH does not include a dynamic HARQ-ACK and does not include any other SPS HARQ-ACK with an SPS configuration in which deferring is not enabled. Further, in this case, the PUCCH may include only an SPS HARQ-ACK with an SPS configuration in which deferring is enabled.

Alt.2: The PUCCH includes an SPS HARQ-ACK, SPS HARQ-ACK deferring is enabled for any SPS configuration, and at least one SPS HARQ-ACK bit corresponds to an SPS configuration in which deferring is enabled. Note that, in this case, the PUCCH includes no dynamic HARQ-ACK. Further, in this case, it need not be related to (dependent on) whether another SPS HARQ-ACK with an SPS configuration in which deferring is not enabled is present in the PUCCH. For example, the PUCCH may include only an SPS HARQ-ACK.

Alt. 3: The PUCCH includes an SPS HARQ-ACK, and SPS HARQ-ACK deferring is enabled for any SPS configuration. In this case, the PUCCH includes no dynamic HARQ-ACK. Further, in this case, it need not be related to (dependent on) whether the corresponding SPS configuration enables deferring in the HARQ-ACK PUCCH. For example, the PUCCH may include only an SPS HARQ-ACK.

Alt.4: The PUCCH includes any SPS HARQ-ACK with an SPS configuration in which deferring is enabled. In this case, it need not be related to whether any dynamic HARQ-ACK is present. Further, in this case, it need not be related to whether another SPS HARQ-ACK with an SPS configuration in which deferring is not enabled is present.

Alt.5: The PUCCH includes any SPS HARQ-ACK, and SPS HARQ-ACK deferring is enabled for any SPS configuration. Note that, in this case, it need not be related to whether the corresponding SPS configuration enables deferring in the HARQ-ACK PUCCH. Further, in this case, it need not be related to whether a dynamic HARQ-ACK is present. Further, in this case, it need not be related to whether the SPS HARQ-ACK bit belongs to an SPS configuration in which deferring is enabled.

### Proposal 0-2

In Proposal 0-2, when any SPS configuration in which deferring is enabled is present, the terminal does not assume that an SPS HARQ-ACK PUCCH resource with N_{PUCCH}^{repeat}>1 is configured in “PUCCH-Config.” For example, the terminal does not assume that a priority for the SPS HARQ-ACK bit is configured in “PUCCH-Config.” In other words, when any SPS configuration in which deferring is enabled is present, the terminal does not assume that PUCCH repetition is configured.

Proposal 0 (Proposals 0-1 and 0-2) described above allows a terminal to selectively perform control of PUCCH transmission between PUCCH repetition and SPS HARQ ACK deferring, and thus it is possible to provide a terminal that appropriately operates in a radio system capable of configuring a resource for transmitting a PUCCH in consideration of PUCCH repetition.

### Variation of Proposal 1

In Proposal 1, it is assumed that PUCCH repetition and SPS HARQ-ACK deferring are enabled at the same time in Case 1. Alternatively, it is assumed that PUCCH repetition and SPS HARQ-ACK deferring are configured at the same time.

In the following description, Proposal 1 for Case 1-1 will be described.

### Proposal 1 Case 1-1

Case 1 is a case of a HARQ-ACK PUCCH determined in an initial slot in which an initial SPS HARQ-ACK bit is included and a deferred SPS HARQ-ACK bit is not included and where N_{PUCCH}^{repeat}>1 is determined for the PUCCH. Then, Case 1-1 is a case where a PUCCH resource (e.g., initial PUCCH repetition) in an initial slot overlaps with a semi-static DL or an SSB symbol in Case 1.

To Proposal 1 for Case 1-1, one of the following three options is applied.

Option 1: Follow the Rel-16 rule. For example, the terminal follows the operation of Rel-16. Note that SPS HARQ-ACK deferring of Rel-17 need not be considered in Option 1.

Note that, in Option 1, the terminal performs, for example, an operation of postponing each of PUCCH repetitions colliding with disabled symbols to the next available slot. Note that the PUCCH repetitions to be postponed may include the first PUCCH repetition.

Option 2: The rule of SPS HARQ-ACK deferring of Rel-17 is given priority. For example, the rule of SPS HARQ-ACK deferring of Rel-17 takes priority over the rule of Rel-16.

In Option 2, conditions under which SPS HARQ-ACK deferring is applied include the following examples.

The first condition (hereinafter, referred to as Option 2-A) is that only SPS HARQ-ACKs are present in a HARQ-ACK PUCCH in an initial slot (e.g., dynamic HARQ-ACK is not multiplexed), and any SPS HARQ-ACK in the HARQ-ACK PUCCH corresponds to an SPS PDSCH configuration in which deferring is enabled. Note that the SPS PDSCH configuration may be read as SPS configuration.

The second condition (hereinafter, referred to as Option 2-B) is that only SPS HARQ-ACKs are present in a HARQ-ACK PUCCH in an initial slot (e.g., dynamic HARQ-ACK is not multiplexed), and all of the SPS HARQ-ACKs in the HARQ-ACK PUCCH correspond to an SPS PDSCH configuration in which deferring is enabled.

Note that, in Option 2, for example, the terminal performs an operation of deferring transmission of an SPS HARQ-ACK bit targeted for deferring to the target PUCCH slot.

Note that, when the condition for applying SPS HARQ-ACK deferring, such as the above-described condition of Option 2-A or Option 2-B, is not satisfied, no PUCCH may be transmitted. In other words, no PUCCH repetition may be transmitted in this case.

Alternatively, the condition for applying SPS HARQ-ACK deferring, such as the above-described condition of Option 2-A or Option 2-B, is not satisfied, the terminal may follow the Rel-16 rule. In this case, PUCCH repetition postponing may be applied, and PUCCH repetition may be postponed.

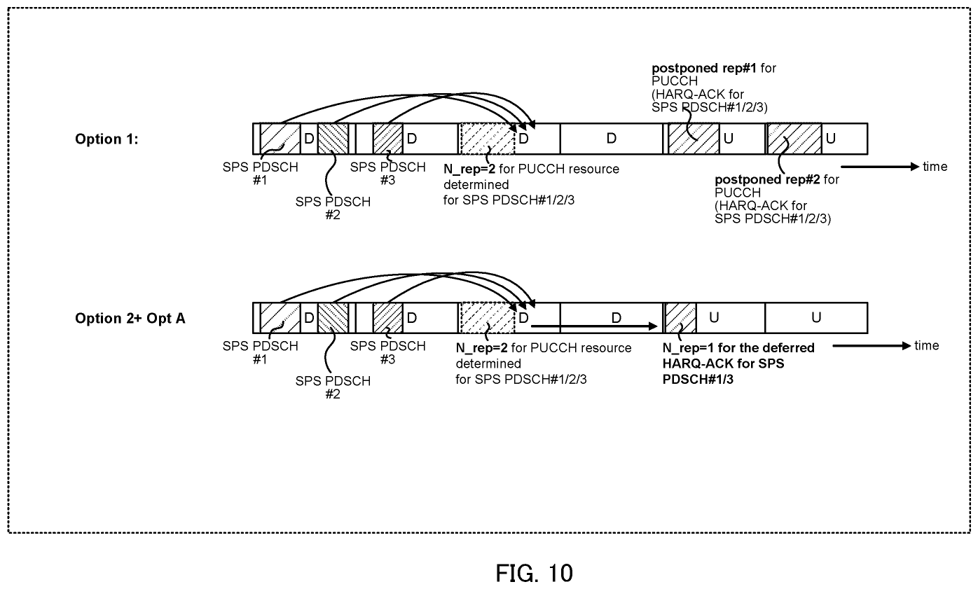

The above-mentioned Options 1 and 2 will be described with reference to the drawings. FIG. 10 illustrates an example of Proposal 1 in Case 1-1. FIG. 10 illustrates an example of Option 1 and an example in which Option 2-A of Option 2 is applied. Six slots are illustrated for each example. The letter “D” of each slot indicates a DL slot, and the letter “U” indicates a UL slot. Further, the first slot in each example includes SPS PDSCH #1 and SPS PDSCH #2, and the second slot includes SPS PDSCH #3.

A case is herein exemplarily described where SPS HARQ-ACK deferring is enabled for SPS configurations of SPS PDSCH #1 and SPS PDSCH #3 and is disabled for an SPS configuration of SPS PDSCH #2, and SPS HARQ-ACKs for respective SPS PDSCHs may be transmitted in the third slot. In this case, the SPS HARQ-ACKs overlap with a semi-static DL in the third slot.

In Option 1 in FIG. 10, N_rep=2 for a PUCCH resource determined for SPS PDSCH #1, SPS PDSCH #2, and SPS PDSCH #3. As described above, in Option 1, the terminal follows the operation of Rel-16 in accordance with the Rel-16 rule, and thus performs the operation of PUCCH repetition postponing. In Option 1 in FIG. 10, the first PUCCH repetition is postponed to the fifth slot, and the first PUCCH repetition (“postponed rep #1” in FIG. 10) is transmitted in the fifth slot. Then, the second PUCCH repetition (“postponed rep #2” in FIG. 10) is transmitted in the sixth slot. Note that the first PUCCH repetition and the second PUCCH repetition may be repetitions for HARQ-ACKs for SPS PDSCH #1, SPS PDSCH #2, and SPS PDSCH #3.

In Option 2 in FIG. 10, N_rep=2 for a PUCCH resource determined for SPS PDSCH #1, SPS PDSCH #2, and SPS PDSCH #3. As described above, in Option 2, the rule of SPS HARQ-ACK deferring of Rel-17 is given priority. Further, as the exemplary application condition, the condition of Option 2-A is that only SPS HARQ-ACKs are present in a HARQ-ACK PUCCH in an initial slot (e.g., dynamic HARQ-ACK is not multiplexed), and any SPS HARQ-ACK in the HARQ-ACK PUCCH corresponds to an SPS PDSCH configuration in which deferring is enabled.

In the example of Option 2 in FIG. 10, only SPS HARQ-ACKs (HARQ-ACKs for SPS PDSCH #1, SPS PDSCH #2, and SPS PDSCH #3) are present in the HARQ-ACK PUCCH in the third slot, which is an initial slot. Further, HARQ-ACKs for SPS PDSCH #1 and SPS PDSCH #3 in the HARQ-ACK PUCCH correspond to an SPS PDSCH configuration in which deferring is enabled. That is, the condition of Option 2-A is satisfied in the example of Option 2 in FIG. 10, and thus the rule of SPS HARQ-ACK deferring is applied. Then, the deferred SPS HARQ-ACK is transmitted in the fifth slot, which is a target slot. Note that the HARQ-ACK to be transmitted may be herein a HARQ-ACK corresponding to the SPS PDSCH configuration in which deferring is enabled (HARQ-ACKs for SPS PDSCH #1 and SPS PDSCH #3 in FIG. 10).

Note that, in the example of Option 2 in FIG. 10, N_rep=1 is configured for a PUCCH resource in the fifth slot.

In addition to Option 1 and Option 2 described above, the following Option 3 may be applied to Proposal 1 for Case 1-1.

Option 3: The rule of Rel-16 PUCCH repetition postponing is applied and integrated with a limitation on SPS HARQ-ACK deferring of Rel-17.

For example, a maximum deferral limitation configured for each SPS configuration is used for postponing restriction of PUCCH repetition in accordance with the Rel-16 rule. For example, the maximum deferral limitation is represented by K1_eff_max=K1+K_max_def. Note that K1_eff_max may be represented as “K1_{eff_max}.”

For application of Option 3, four points will be exemplarily described.

### Point 1: Definition of Postponing Restriction

For example, the postponing restriction is defined by a slot offset from a deferred repetition to an SPS PDSCH slot. In other words, the postponing restriction is defined by an interval (or distance) between a slot including a referred repetition and an SPS PDSCH slot. This interval may be represented, for example, by the number of slots. In the following description, this offset will be denoted as K1_rep. Note that K1_rep may be represented as “K1ᵣₑₚ.”

For example, the following restriction may be applied to K1_rep.

Alt-A: K1_rep≤SK1_eff_max

K1_eff_max herein indicates a maximum deferral limitation. For example, K1_eff_max may be configured for each SPS configuration in accordance with Rel-17. Note that, the maximum deferral limitation may be K1_eff_max=K1 in the SPS configuration in which deferring is not enabled. Further, Alt-A may be K1_rep<K1_eff_max.

Alt-B: K1_rep≤SK1_eff_max+N_rep

K1_eff_max herein indicates a maximum deferral limitation. For example, K1_eff_max may be configured for each SPS configuration in accordance with Rel-17. Note that the maximum deferral limitation may be K1_eff_max=K1 in the SPS configuration in which deferring is not enabled. Further, Alt-B may be K1_rep<K1_eff_max+N_rep.

Furthermore, N_rep represents the number of PUCCH repetitions. The number of PUCCH repetitions represented by N_rep may be the number of PUCCH repetitions that can be performed.

Note that N_rep may be a factor of PUCCH repetition (e.g., N_{PUCCH}^{repeat}) determined for a PUCCH resource in an initial slot. Hereinafter, this configuration is sometimes referred to as Alt-B1.

Alternatively, N_rep may be a maximum value of a factor of available PUCCH repetition configured for a PUCCH resource in “PUCCH-Config.” Hereinafter, this configuration is sometimes referred to as Alt-B2.

Note that N_rep may be a factor of PUCCH repetition determined for a PUCCH resource in a slot different from the initial slot. Alternatively, N_rep may be a minimum, mean, or median value of a factor of available PUCCH repetition configured for a PUCCH resource in “PUCCH-Config.” Alternatively, N_rep may be a factor different from a factor of PUCCH repetition determined for a PUCCH resource.

### Point 2: Condition for Postponing Restriction

In PUCCH repetition (the first PUCCH repetition or each of PUCCH repetitions including the first PUCCH repetition), it may be determined that a postponing restriction is satisfied in the case of the following Opt. A or Opt. B.

Opt. A: K1_rep restriction is satisfied for all SPS PDSCHs corresponding to HARQ-ACK PUCCHs. In other words, there is no SPS PDSCH for which K1_rep restriction is not satisfied.

Opt. B: K1_rep restriction is satisfied for at least one SPS PDSCH corresponding to a HARQ-ACK PUCCH. In other words, in this case, as long as K1_rep restriction is satisfied for at least one SPS PDSCH, SPS PDSCH for which K1_rep restriction is not satisfied may be present.

Point 3: Target for Confirmation/Application of Postponing Restriction There are variations of Alt.1 and Alt.2 to be described below for the target for confirmation/application of whether the postponing restriction is satisfied.

Alt. 1: The postponing restriction is confirmed and/or applied for the first postponed PUCCH repetition. In other words, the postponing restriction need not be confirmed for and/or applied to PUCCH repetitions other than the first postponed PUCCH repetition.

Alt. 2: The postponing restriction is confirmed for and/or applied to each postponed PUCCH repetition.

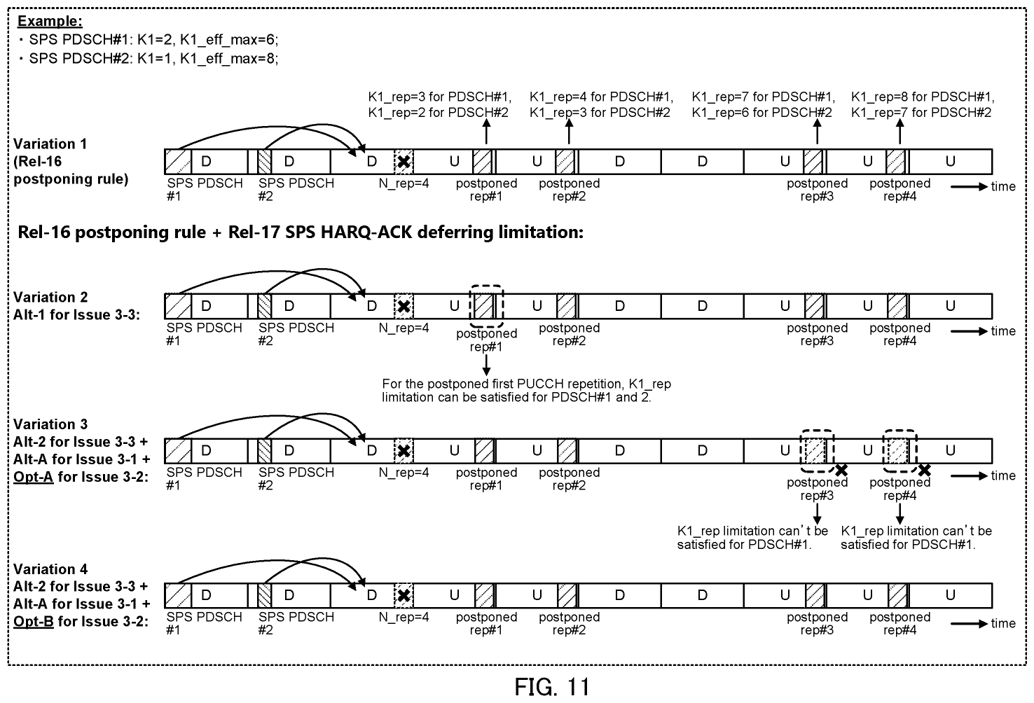

Option 3 of Proposal 1 in above-described Case 1-1 will be herein described with reference to the drawings. FIG. 11 illustrates the first example of Proposal 1 in Case 1-1. Four variations are illustrated in FIG. 11. Ten slots are illustrated for each variation. Note that, as in FIG. 4, the letter “D” of each slot indicates a DL slot, and the letter “U” indicates a UL slot in FIG. 11.

In each variation, the first slot includes SPS PDSCH #1, and the second slot includes SPS PDSCH #2. Exemplarily, K1=2 and K1_eff_max=6 are configured for SPS PDSCH #1, and K1=1 and K1_eff_max=8 are configured for SPS PDSCH #2.

A case will be described in which SPS HARQ-ACKs for respective SPS PDSCHs may be transmitted in the third slot since K1=2 for SPS PDSCH #1 and K1=1 for SPS PDSCH #2. Note that N_rep=4 for a PUCCH that may be transmitted in the third slot.

Variation 1 indicates an example of following the Rel-16 postponing rule as a comparative example for Option 3. In Variation 1, SPS HARQ-ACKs overlap with a semi-static DL in the third slot. Thus, a PUCCH repetition for transmitting the SPS HARQ-ACKs is postponed.

In Variation 1 in FIG. 11, PUCCH repetition is transmitted not in the third slot but in a UL slot of or after the fourth slot. For example, the postponed first PUCCH repetition (“postponed rep #1” in FIG. 11) is transmitted in the fourth slot, and the postponed second, third, and fourth PUCCH repetitions (“postponed rep #2,” “postponed rep #3,” and “postponed rep #4” in FIG. 4) are respectively transmitted in the fifth, eighth, and ninth slots.

Note that, as described above, K1_rep is defined by a slot offset from a deferred repetition to an SPS PDSCH slot. In Variation 1, K1_rep for SPS PDSCH #1 corresponding to postponed rep #1 is K1_rep=3, and K1_rep for SPS PDSCH #2 corresponding to postponed rep #1 is K1_rep=4. For postponed rep #2, postponed rep #3 and postponed rep #4, the value of K1_rep is specified for each of SPS PDSCH #1 and SPS PDSCH #2, similarly to postponed rep #1 and as illustrated in FIG. 11.

Variations 2 to 4 in FIG. 11 indicate examples in which the Rel-16 postponing rule and the Rel-17 SPS HARQ-ACK deferring limitation are integrated. In Variations 2 to 4, PUCCH repetition is postponed as in Variation 1. Slots of PUCCH repetitions are the same as in Variation 1.

Variation 2 in FIG. 11 is an example in which the above-described Alt.1 of Point 3 is applied. In Alt. 1 of Point 3, postponing restriction is confirmed for and/or applied to the first postponed PUCCH repetition.

In Variation 2 in FIG. 11, it is confirmed whether the postponing restriction is satisfied for “postponed rep #1,” which is the first postponed PUCCH repetition. In other words, in Variation 2 in FIG. 11, it need not be confirmed whether the postponing restriction is satisfied for postponed rep #2 to postponed rep #4 except for postponed rep #1, which is the first postponed PUCCH repetition. In the case of Variation 2 in FIG. 11, the postponing restriction is satisfied for “postponed rep #1,” so that “postponed rep #1” to “postponed rep #4” are transmitted.

Variation 3 in FIG. 11 is an example in which above-described Alt. 2 of Point 3, Alt. A of Point 1, and Opt. A of Point 2 are applied. In Alt. 2 of Point 3, the postponing restriction is confirmed for each of the postponed PUCCH repetitions (each of “postponed rep #1” to “postponed rep #4” in FIG. 11). In Opt. A of Point 2, the postponing restriction is determined to be satisfied when the K1_rep restriction is satisfied for all of SPS PDSCHs corresponding to HARQ-ACK PUCCHs. In Alt. A of Point 1, the K1_rep restriction is “K1_rep≤K1_eff_max.” In other words, in Variation 3 in FIG. 11, the postponing restriction is confirmed for each of “postponed rep #1” to “postponed rep #4.” Then, when K1_rep for SPS PDSCH #1 corresponding to “postponed rep” and K1_rep for SPS PDSCH #2 corresponding to “postponed rep” both satisfy “K1_rep≤K1_eff_max,” the postponing restriction is determined to be satisfied.

In Variation 3 in FIG. 11, K1_rep for SPS PDSCH #1 corresponding to postponed rep #1 is K1_rep=3, K1_eff_max for SPS PDSCH #1 is K1_eff_max=6, and thus “K1_rep≤K1_eff_max” is satisfied. Further, K1_rep for SPS PDSCH #2 corresponding to postponed rep #1 is K1_rep=4, K1_eff_max for SPS PDSCH #2 is K1_eff_max=8, and thus “K1_rep≤K1_eff_max” is satisfied. Accordingly, SPS PDSCH #1 and SPS PDSCH #2 corresponding to postponed rep #1 both satisfy “K1_rep≤K1_eff_max,” and thus the postponing restriction is satisfied. In this case, SPS HARQ-ACKs for SPS PDSCH #1 and SPS PDSCH #2 may be transmitted in postponed rep #1. Further, in postponed rep #2, SPS PDSCH #1 and SPS PDSCH #2 both satisfy the postponing restriction as in postponed rep #1.

In Variation 3 in FIG. 11, K1_rep for SPS PDSCH #1 corresponding to postponed rep #3 is K1_rep=7, K1_eff_max for SPS PDSCH #1 is K1_eff_max=6, and thus “K1_rep≤K1_eff_max” is not satisfied. Further, K1_rep for SPS PDSCH #2 corresponding to postponed rep #3 is K1_rep=6, K1_eff_max for SPS PDSCH #2 is K1_eff_max=8, and thus “K1_rep≤K1_eff_max” is satisfied. Accordingly, SPS PDSCH #1 corresponding to postponed rep #3 does not satisfy “K1_rep≤K1_eff_max,” and thus the postponing restriction is not satisfied. In this case, an SPS HARQ-ACK for SPS PDSCH #1 is not transmitted (is dropped) in postponed rep #3. Further, in this case, an SPS HARQ-ACK for SPS PDSCH #2 may be transmitted or need not be transmitted in postponed rep #3. Further, in postponed rep #4, SPS PDSCH #1 does not satisfy the postponing restriction and SPS PDSCH #2 satisfies the postponing restriction as in postponed rep #3.

Variation 4 is an example in which Alt. 2 of Point 3, Alt. A of Point 1, and Opt. B of Point 2 are applied.

Variation 4 in FIG. 11 is an example in which above-described Alt. 2 of Point 3, Alt. A of Point 1, and Opt. B of Point 2 are applied. In Alt.2 of Point 3, the postponing restriction is confirmed for each of the postponed PUCCH repetitions (each of “postponed rep #1” to “postponed rep #4” in FIG. 11). In Opt. B of Point 2, the postponing restriction is determined to be satisfied when K1_rep restriction is satisfied for at least one SPS PDSCH corresponding to a HARQ-ACK PUCCH. In Alt. A of Point 1, the K1_rep restriction is “K1_rep≤K1_eff_max.” In other words, in Variation 4 in FIG. 11, the postponing restriction is confirmed for each of “postponed rep #1” to “postponed rep #4.” Then, when at least one of K1_rep for SPS PDSCH #1 corresponding to “postponed rep” and K1_rep for SPS PDSCH #2 corresponding to “postponed rep” satisfies “K1_rep≤K1_eff_max,” the postponing restriction is determined to be satisfied.

In Variation 4 in FIG. 11, SPS PDSCH #1 and SPS PDSCH #2 corresponding to postponed rep #1 both satisfy “K1_rep≤K1_eff_max” similarly to the example described in Variation 3, and thus the postponing restriction is satisfied. In this case, SPS HARQ-ACKs for SPS PDSCH #1 and SPS PDSCH #2 may be transmitted in postponed rep #1. Further, in postponed rep #2, as in postponed rep #1, SPS PDSCH #1 and SPS PDSCH #2 both satisfy “K1_rep≤K1_eff_max”, and thus the postponing restriction is satisfied.

Further, in Variation 4 in FIG. 11, as in the example described in Variation 3, SPS PDSCH #1 corresponding to postponed rep #3 does not satisfy “K1_rep≤K1_eff_max,” and SPS PDSCH #2 satisfies “K1_rep≤K1_eff_max.” In Variation 4, unlike Variation 3, the postponing restriction is determined to be satisfied when K1_rep restriction is satisfied for at least one SPS PDSCH corresponding to a HARQ-ACK PUCCH, so that the postponing restriction is satisfied for postponed rep #3 in Variation 4. In this case, SPS HARQ-ACKs for SPS PDSCH #1 and SPS PDSCH #2 may be transmitted in postponed rep #3. Further, as in postponed rep #3, the postponing restriction is satisfied in postponed rep #4.

### Point 4: Application Condition for SPS HARQ-ACK Deferring Limitation

Application conditions for applying SPS HARQ-ACK deferring limitation to a certain PUCCH include the following conditions. Note that the application conditions are not limited to the following examples.

Condition 1: An SPS HARQ-ACK with an SPS PDSCH configuration in which deferring is enabled is present in the PUCCH. Note that the number of SPS HARQ-ACKs may be one or more in this condition. Further, no dynamic HARQ-ACK may be present in the PUCCH, and no other SPS HARQ-ACK with an SPS configuration in which deferring is not enabled may be present. Further, in this case, the PUCCH may include only an SPS HARQ-ACK with an SPS configuration in which deferring is enabled.

Condition 2: An SPS HARQ-ACK is present in the PUCCH, and at least one SPS HARQ-ACK corresponds to an SPS configuration in which deferring is enabled. Note that, in this case, no dynamic HARQ-ACK may be present. Further, it need not be related to (dependent on) whether another SPS HARQ-ACK with an SPS configuration in which deferring is not enabled is present in the PUCCH. For example, the PUCCH may include only an SPS HARQ-ACK.

Condition 3: An SPS HARQ-ACK is present in the PUCCH, and SPS HARQ-ACK deferring is enabled for any SPS. Note that no dynamic HARQ-ACK may be present in the PUCCH. Further, it need not be related to whether an SPS HARQ-ACK bit belongs to an SPS configuration in which deferring is enabled. For example, the PUCCH may include only an SPS HARQ-ACK.

Condition 4: Any HARQ-ACK with an SPS PDSCH configuration in which deferring is enabled is present in the PUCCH. Note that, in this case, it need not be related to whether a dynamic HARQ-ACK is present. Further, it need not be related to whether a HARQ-ACK with another SPS configuration in which deferring is not enabled is present.

Condition 5: Any SPS HARQ-ACK is present in the PUCCH, and SPS HARQ-ACK deferring with any SPS configuration is enabled. Note that it need not be related to whether a dynamic HARQ-ACK is present. Further, it need not be related to whether an SPS HARQ-ACK bit belongs to an SPS configuration in which deferring is enabled.

Note that the conventional Rel-16 PUCCH repetition postponing rule may be applied when the application condition is not satisfied.

Next, Proposal 1 for Case 1-2 will be described.

### Proposal 1 Case 1-2

Case 1-2 is a case where a PUCCH resource in an initial slot (e.g., the first PUCCH repetition) does not overlap with a disabled symbol (e.g., semi-static DL or SSB symbol), and one or more PUCCH repetitions other than the first PUCCH repetition overlap with a semi-static DL or an SSB symbol.

In Proposal 1 for Case 1-2, any of the following options is applied.

Option 1: Follow the Rel-16 rule. For example, the terminal follows the operation of Rel-16. This is the same as Option 1 of Proposal 1 for Case 1-1.

Note that, in Option 1, any PUCCH repetition that collides with a disabled symbol may be postponed to the next available slot.

Option 2: The Rel-17 SPS HARQ-ACK deferring limitation is applied to the Rel-16 PUCCH repetition postponing restriction.

For example, in Option 2 of Proposal 1 for Case 1-2, above-described Option 3 of Proposal 1 for Case 1-1 may be applied. Exemplarily, Option 3 with Alt. 2 for Point 3 described in Option 3 may be applied.

According to Proposal 1 described above, the terminal can selectively perform control of PUCCH transmission between PUCCH repetition and SPS HARQ ACK deferring or control of PUCCH transmission in a system where PUCCH repetition and SPS HARQ ACK deferring is integrated. Therefore, the terminal can appropriately operate in a radio system capable of configuring a resource for transmitting a PUCCH in consideration of PUCCH repetition.

Further, in Proposal 1 described above, it is possible to appropriately control PUCCH transmission including a configuration of a resource for transmitting a PUCCH for both Case 1-1 and Case 1-2.

Note that an example in which Proposal 1 is applied to both Cases 1-1 and 1-2 has been described above, but the present disclosure is not limited thereto. Proposal 1 may be applied to a case other than Cases 1-1 and 1-2.

### Proposal 2 Case 2

As described above, Case 2 is a case of a HARQ-ACK PUCCH including a deferred SPS HARQ-ACK bit and where N_{PUCCH}^{repeat}>1 is determined for the PUCCH in the target slot.

In Proposal 2 for Case 2, any of the following three options is applied.

Option 0: Processed as an error case. In this case, both SPS HARQ-ACK deferring and a PUCCH repetition operation need not be executed, or either one of them may be executed and the other need not be executed. An operation to be executed may be specified in advance by the specification, or information on an operation to be executed may be indicated to the terminal. The indication method need not be particularly limited.

Option 1: Do not perform PUCCH repetition of a HARQ-ACK PUCCH that is in a target slot and includes a deferred SPS HARQ-ACK.

In the case of Optional 1, the terminal assumes N_rep=1 when a deferred SPS HARQ-ACK is present in the PUCCH. In this case, a PUCCH repetition factor for a PUCCH resource or a PUCCH format may be ignored.

Option 2: PUCCH repetition of a HARQ-ACK PUCCH that is in a target slot and includes a deferred SPS HARQ-ACK may be applied.

For this Option 2, any of the following Options 2-1 and 2-2 may be applied.

Option 2-1: N_rep is determined in the same manner as determination of the legacy PUCCH repetition factor. For example, N_rep is determined to be N_{PUCCH}^{repeat}. The determination of the legacy PUCCH repetition factor may be, for example, a method defined in Rel-16 or a release before Rel-16.

Option 2-2: N_rep is determined based on a combination of determination of a legacy PUCCH repetition factor and a maximum deferral limitation for each of SPS configurations. For example, the determination of the legacy PUCCH repetition factor corresponds to determining N_{PUCCH}^{repeat}. Further, for example, the maximum deferral limitation for each of SPS configurations means a limitation value obtained by K1_eff_max=K1+K_max_def as described above.

Exemplary determination of N_rep in Option 2-2 will be described. For example, in the first exemplary determination (hereinafter, referred to as Option 2-2A), it is intended by N_rep that the last repetition of PUCCH repetitions is ensured to be within the maximum deferral limitation for each of SPS PDSCHs.

For example, N_rep is determined by Expression 1.

$$\begin{matrix}[ 1 ] & \\ N\_rep = min [ {min}_{SPS PDSCH} ( K1\_eff \_max - K1\_eff + 1 ) , {N}_{PUCCH}^{repeat} ] & Expression 1\end{matrix}$$

Another exemplary determination of N_rep in Option 2-2 will be described. In the second exemplary determination (hereinafter, referred to as Option 2-2B), it is intended by N_rep that the last repetition of PUCCH repetitions is ensured to be within the maximum deferral limitation for at least one SPS PDSCH.

For example, N_rep is determined by Expression 2.

$$\begin{matrix}[ 2 ] & \\ N\_rep = min [ {max}_{SPS PDSCH} ( K1\_eff \_max - K1\_eff + 1 ) , {N}_{PUCCH}^{repeat} ] . & Expression 2\end{matrix}$$

K1_eff in Expressions 1 and 2 herein represents a slot offset from an SPS PDSCH slot to the target slot, and K1_eff_max represents a maximum deferral limitation configured for each SPS configuration in accordance with Rel-17. Note that, the maximum deferral limitation may be K1_eff_max=K1 for an SPS configuration in which deferring is not enabled.

For the above-described variation of Proposal 2 for Case 2, there may be a plurality of sub-cases for Case 2. For example, the sub-cases are as follows:
Case 2-1: Case where a PUCCH in a target slot includes new HARQ-ACKs,
Case 2-1A: The new HARQ-ACKs include only new SPS HARQ-ACKs,
Case 2-1B: The new HARQ-ACKs include only new dynamic HARQ-ACKs,
Case 2-1C: The new HARQ-ACKs include a new dynamic HARQ-ACK and a new SPS HARQ-ACK, and
Case 2-2: Case where a HARQ-ACK PUCCH in a target slot includes a deferred SPS HARQ-ACK bit.

The new HARQ-ACK may be herein a HARQ-ACK that is not a deferred HARQ-ACK.

In Proposal 2 for Case 2, a different option may be applied for each above-described sub-case for Case 2. For example, Option 1 is applied to Case 2-2, and Option 2-1 is applied to Case 2-1A.

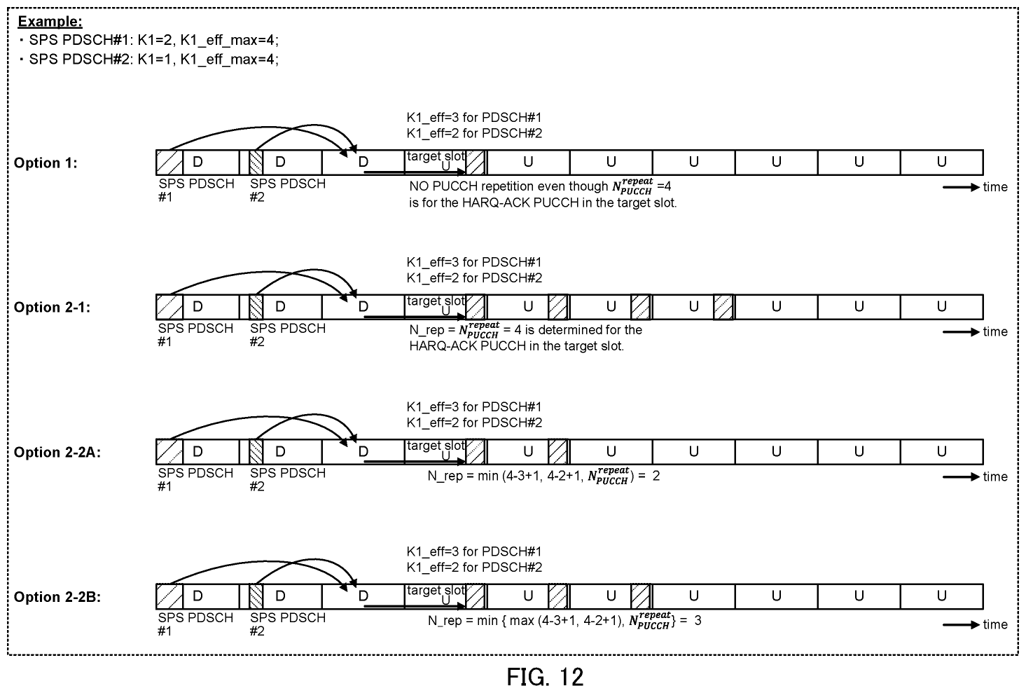

Variations of Proposal 2 in the above-described Case 2 will be described with reference to the drawings. FIG. 12 illustrates the first example of Proposal 2 in Case 2. Four options are illustrated in FIG. 12. For each option, ten slots are illustrated. Note that, as in FIG. 4, the letter “D” of each slot indicates a DL slot, and the letter “U” indicates a UL slot in FIG. 12.

In each option, the first slot includes SPS PDSCH #1, and the second slot includes SPS PDSCH #2. Exemplarily, K1=2 and K1_eff_max=4 are configured for SPS PDSCH #1, and K1=1 and K1_eff_max=4 are configured for SPS PDSCH #2.

A case will be described in which SPS HARQ-ACKs for respective SPS PDSCHs may be transmitted in the third slot since K1=2 for SPS PDSCH #1 and K1=1 for SPS PDSCH #2, and N_{PUCCH}^{repeat}=4. Note that, as illustrated in FIG. 12, SPS HARQ-ACKs overlap with a semi-static DL in the third slot in each Option.

In Option 1 of Proposal 2 in Case 2, PUCCH repetition of a HARQ-ACK PUCCH that is in the target slot and includes a deferred SPS HARQ-ACK is not performed. Thus, in Option 1 in FIG. 12, a deferred SPS HARQ-ACK is transmitted in the fourth UL slot, and PUCCH repetition is not performed.

In Option 2-1 of Proposal 2 in Case 2, N_rep is determined in the same manner as the legacy PUCCH repetition factor is determined. Thus, in Option 2-1 in FIG. 12, N_rep=N_{PUCCH}^{repeat}=4 is determined, and PUCCH repetition is performed in four slots from the fourth slot to the seventh slot.

In Option 2-2 of Proposal 2 in Case 2, N_rep is determined based on a combination of the determination of the legacy PUCCH repetition factor and the maximum deferral limitation for each of SPS configurations. Then, in Option 2-2A, the last repetition of PUCCH repetitions is endured to be within the maximum deferral limitation for each of SPS PDSCHs by N_rep.

In Option 2-2A in FIG. 12, K1_eff for SPS PDSCH #1 is K1_eff=3 in the fourth slot, and thus it is calculated as K1_eff_max-K1_eff+1=4-3+1. Further, K1_eff for SPS PDSCH #1 is K1_eff=2, and thus it is calculated as K1_eff_max-K1_eff+1=4-2+1. Thus, N_rep is determined to be N_rep=min[min(4-3+1, 4-2+1), N_{PUCCH}^{repeat}]=2 by Expression 1. In Option 2-2A in FIG. 12, two PUCCH repetitions are performed in accordance with N_rep=2.

In Option 2-2 of Proposal 2 in Case 2, N_rep is determined based on a combination of determination of a legacy PUCCH repetition factor and a maximum deferral limitation for each of SPS configurations. Then, in Option 2-2B, the last repetition of PUCCH repetitions is ensured to be within the maximum deferral limitation for at least one SPS PDSCH by N_rep.

In Option 2-2B in FIG. 12, as in Option 2-2A, K1_eff for SPS PDSCH #1 is K1_eff=3 in the fourth slot, and thus it is calculated as K1_eff_max-K1_eff+1=4-3+1. Further, K1_eff for SPS PDSCH #1 is K1_eff=2, and thus it is calculated as K1_eff_max-K1_eff+1=4-2+1. Accordingly, N_rep is determined as N_rep=min[max(4-3+1, 4-2+1), N_{PUCCH}^{repeat}]=3 by Expression 2. In Option 2-2B in FIG. 12, three PUCCH repetitions are performed in accordance with N_rep=3.

### (Supplement to Option 2 of Proposal 2)

The definition of the target slot ensures that the first PUCCH repetition in the target slot does not overlap with a disabled symbol (e.g., semi-static DL or SSB symbol). However, PUCCH repetitions following the first PUCCH repetition possibly overlap with the disabled symbol. An operation of the terminal in such a case will be described.

For example, for a PUCCH including a deferred SPS HARQ-ACK bit, any of the following is selected when a PUCCH repetition other than the first PUCCH repetition overlaps with a semi-static DL or an SSB symbol.

Alt 1: The Rel-16 PUCCH repetition postponing rule is not applied.

In this case, PUCCH repetition may be dropped for a PUCCH repetition that is other than the first PUCCH repetition and overlaps with a semi-static DL or an SSB symbol.

Alt.2: The conventional Rel-16 PUCCH repetition postponing rule may be applied.

For example, a PUCCH including a deferred SPS HARQ-ACK bit is treated in the same manner as Rel-16 PUCCH. In this case, a PUCCH repetition that is other than the first PUCCH repetition and overlaps with a semi-static DL or an SSB symbol may be postponed to the next available slot. The next available slot may be an available slot subsequent to the overlapping slot.

Alt. 3: The Rel-16 PUCCH repetition postponing rule is applied, but the rule is integrated with the Rel-17 SPS HARQ-ACK deferring limitation.

For example, in this case, above-described Option 3 of Proposal 1 for Case 1-1 may be applied. Exemplarily, Option 3 with Alt. 2 for Point 3 described in Option 3 may be applied.

Note that different options may be applied to different sub-cases. For example, Alt. 1 may be applied to Case 2-2, and Alt. 2 may be applied to Case 2-2.

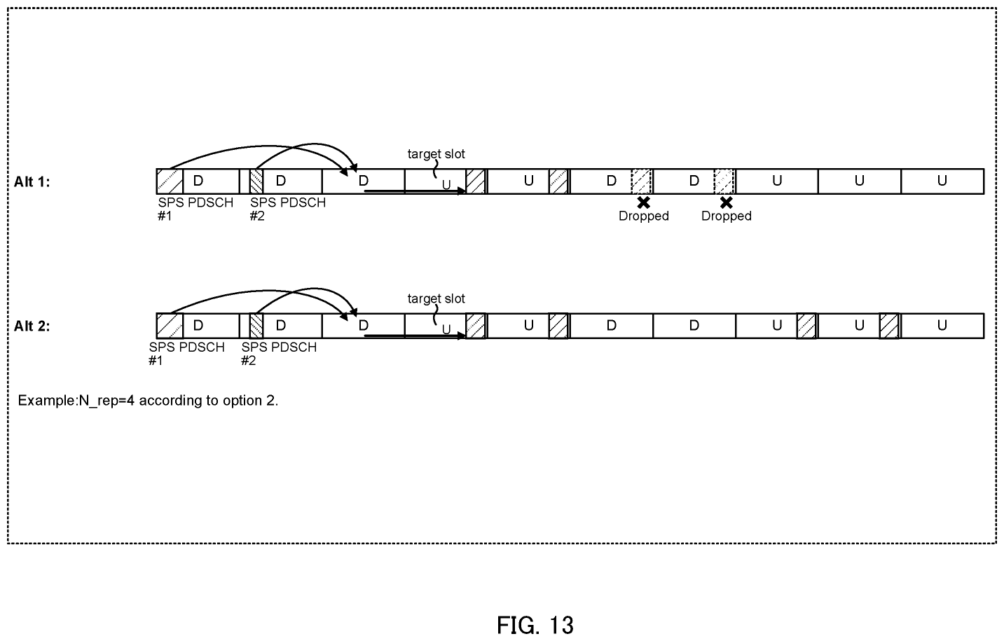

Alt. 1 and Alt. 2 will be herein described with reference to the drawings. FIG. 13 illustrates supplements to Option 2 of Proposal 2. FIG. 13 illustrates Alt. 1 and Alt. 2. For each of Alt.1 and Alt.2, ten slots are illustrated. Note that, as in FIG. 4, the letter “D” of each slot indicates a DL slot, and the letter “U” indicates a UL slot in FIG. 13.

In the examples of Alt.1 and Alt.2, the first slot includes SPS PDSCH #1 in the first slot, and the second slot includes SPS PDSCH #2 in the second slot. Further, a case will be described in which SPS HARQ-ACKs for respective SPS PDSCHs are transmitted in the third slot. In the third slot, SPS HARQ-ACKs overlap with a semi-static DL. Thus, a PUCCH repetition for transmitting the SPS HARQ-ACKs is postponed.

In the example in FIG. 13, the first PUCCH repetition in the fourth slot, which is a target slot, does not overlap with a disabled symbol (e.g., semi-static DL or SSB symbol). However, the third PUCCH repetition (sixth slot) and the fourth PUCCH repetition (seventh slot) following the first PUCCH repetition overlap with disabled symbols.

In Alt. 1, the Rel-16 PUCCH repetition postponing rule is not applied. Thus, in Alt. 1 in FIG. 13, the third and fourth PUCCH repetitions that overlap with disabled symbols are not transmitted (are dropped).

In Alt. 2, the conventional Rel-16 PUCCH repetition postponing rule may be applied. Thus, in Alt. 2 in FIG. 13, the third and fourth PUCCH repetitions that overlap with disabled symbols are further postponed. In Alt. 2 in FIG. 13, the postponed third and fourth PUCCH repetitions are transmitted in the eighth and ninth slots, respectively.

According to Proposal 2 described above, the terminal can selectively perform control of PUCCH transmission between PUCCH repetition and SPS HARQ ACK deferring or control of PUCCH transmission in a system where PUCCH repetition and SPS HARQ ACK deferring is integrated. Therefore, the terminal can appropriately operate in a radio system capable of configuring a resource for transmitting a PUCCH in consideration of PUCCH repetition.

Further, in Proposal 2 described above, it is possible to appropriately control PUCCH transmission including a configuration of a resource for transmitting a PUCCH for Case 2.

Note that an example in which Proposal 2 is applied to Case 2 has been described above, but the present disclosure is not limited thereto. Proposal 2 may be applied to a case other than Case 2.

By adopting any of Proposals and Options (or Alternation (Alt.)) of the Proposals described above, the terminal can appropriately operate in a radio system capable of configuring a resource for transmitting an uplink signal (e.g., signal including an SPS HARQ-ACK) in consideration of repetition of an uplink signal (e.g., signal of PUCCH).

In each proposal described above, which option (or alternation (Alt.)) to be used among options (or Alts.) of each proposal may be specified by the specification or may be configured by a higher layer parameter. Further, which option (or alternation (Alt.)) to be used among options (or Alts.) of each proposal may be reported by the terminal with terminal capability information (e.g., “UE capability”). Furthermore, which option (or alternation (Alt.)) to be used among options (or Alts.) of each proposal may be determined by a combination of the configuration of the higher layer parameter and the reported terminal capability information. For example, the base station may determine one or more options (or Alt.) among options (or Alts.) that are available for the terminal and indicated by the reported terminal capability information, and the determined information may be configured by the higher layer parameter. Note that the present disclosure is not limited to the case where the option (Alt.) is configured by the higher layer parameter, and information on the option (or Alt.) to be used may be indicated by control information (e.g., DCI) of a physical layer.

Note that the term “slot” may be replaced with a “sub-slot” in the present embodiment. Further, in the above-described embodiment, the “slot” is a term indicating a certain time interval and may be replaced with another expression. For example, the “slot” may be replaced with another expression such as “symbol,” “time interval,” or “time resource.”

Note that SPS is exemplified in the present embodiment, but the present disclosure is not limited thereto. For example, the present disclosure may be applied to persistent scheduling or dynamic scheduling instead of SPS.

Further, in the present embodiment, an SPS PDSCH and an SPS HARQ-ACK for the SPS PDSCH are exemplified, but the present disclosure is not limited thereto. For example, the present disclosure may be applied to a data channel different from the SPS PDSCH and a confirmation response for the data channel. Furthermore, the present disclosure may be applied not only to a data channel but also to a control channel (e.g., PDCCH) and a confirmation response for the control channel. Moreover, the present disclosure may be applied to feedback information different from the SPS HARQ-ACK.

Different options (or Alts.) may be applied to different PUCCH repetition schemes. For example, options of each proposal applied to a slot-based PUCCH repetition scheme and options of each proposal applied to a sub-slot-based PUCCH repetition scheme may be different from each other.

The terminal capability information (UE capability) may include, for example, information specifying whether the terminal supports PUCCH repetition, information specifying whether the terminal supports SPS HARQ-ACK deferring, and information specifying whether the terminal supports the PUCCH repetition and the SPS HARQ-ACK deferring at the same time. Further, the terminal capability information may include information indicating whether the terminal supports each above-described proposal and/or whether the terminal supports each option (or each Alt.) of each proposal.

Note that, in the present embodiment, the expressions of deferral and postponing may be replaced with each other. Further, the deferral and the postponing may be each replaced with another expression such as delay or procrastination.

Further, in the present embodiment, the expressions of limitation and restriction may be replaced with each other. Furthermore, the expressions of limitation and restriction may be replaced with another expression such as constraint or restraint.

### <Example of Radio Communication System>

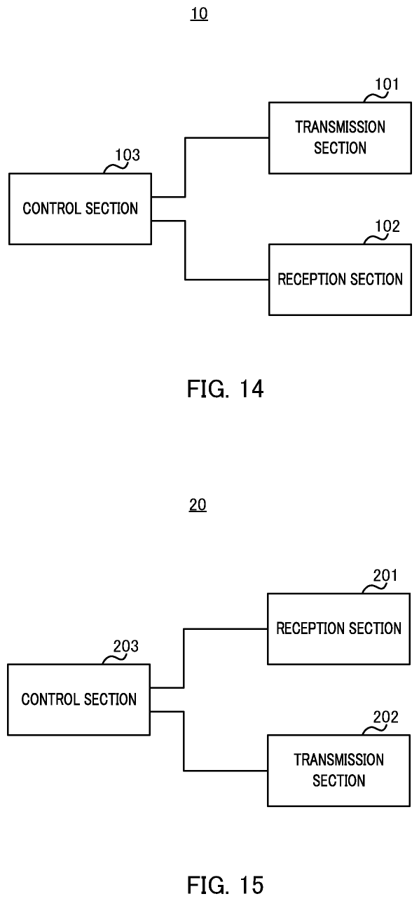

A radio communication system according to the present embodiment includes base station 10 illustrated in FIG. 14 and terminal 20 illustrated in FIG. 15. The number of base stations 10 and the number of terminals 20 are not particularly limited. The radio communication system may be a system in which two base stations 10 communicate with one terminal 20. The radio communication system may be a radio communication system conforming to New Radio (NR). Illustratively, the radio communication system may be a radio communication system conforming to a system called URLLC and/or IIoT.

Note that the radio communication system may be a radio communication system conforming to a system called 5G, Beyond 5G, 5G Evolution, or 6G.

Base station 10 may be referred to as an NG-RAN Node, an ng-eNB, an eNodeB (eNB), or a gNodeB (gNB). Terminal 20 may be referred to as User Equipment (UE). Further, base station 10 may be regarded as an apparatus included in a network to which terminal 20 is connected.

The radio communication system may include a Next Generation-Radio Access Network (hereinafter, referred to as NG-RAN). The NG-RAN includes a plurality of NG-RAN Nodes, specifically a plurality of gNBs (or ng-eNBs), and is connected to a core network (5GC, not illustrated) conforming to 5G. Note that, the NG-RAN and the 5GC may be simply represented as “network.”

Base station 10 performs radio communication with terminal 20. For example, the radio communication to be performed conforms to NR. At least one of base station 10 and terminal 20 may support Massive Multiple-Input Multiple-Output (MIMO), which generates a beam (BM) having higher directivity by controlling radio signals transmitted from a plurality of antenna elements. Further, at least one of base station 10 and terminal may support carrier aggregation (CA), which aggregates and uses a plurality of component carriers (CC). Further, at least one of base station 10 and terminal 20 may support dual connectivity (DC) or the like in which communication is performed between terminal 20 and each of a plurality of base stations 10.

The radio communication system may support a plurality of frequency bands. For example, the radio communication system supports Frequency Range (FR) 1 and FR 2. For example, the frequency bands of the FRs are as follows:
FR1: 410 MHz to 7.125 GHz
FR2: 24.25 GHz to 52.6 GHz

In FR 1, Sub-Carrier Spacing (SCS) of 15 kHz, 30 kHz or 60 kHz may be used, and a bandwidth (BW) of 5 MHz to 100 MHz may be used. FR 2 is higher than FR 1, for example. In FR 2, SCS of 60 kHz or 120 kHz may be used and a bandwidth (BW) of 50 MHz to 400 MHz may be used. FR 2 may also include SCS of 240 kHz.

The radio communication system in the present embodiment may support a frequency band higher than the frequency band of FR 2. For example, the radio communication system in the present embodiment may support a frequency band exceeding 52.6 GHz and up to 114.25 GHz. Such a high frequency band may be referred to as “FR 2x.”

Further, Cyclic Prefix-Orthogonal Frequency Division Multiplexing (CP-OFDM)/Discrete Fourier Transform-Spread-Orthogonal Frequency Division Multiplexing (DFT-S-OFDM) having sub-carrier spacing (SCS) larger than that in the examples described above may be applied. Further, the DFT-S-OFDM may be applied to either one or both of uplink and downlink.

In the radio communication system, a slot configuration pattern of Time Division Duplex (TDD) may be configured. For example, in the slot configuration pattern, a pattern indicating the order of two or more slots among a slot for transmitting a downlink (DL) signal, a slot for transmitting an uplink (UL) signal, a slot in which a DL signal, a UL signal, and a guard symbol are mixed, and a slot in which a signal to be transmitted is flexibly changed may be specified.

Further, in the radio communication system, it is possible to perform PUSCH (or Physical Uplink Control Channel (PUCCH)) channel estimation by using a demodulation reference signal (DMRS) per slot, but it is further allowed to perform PUSCH (or PUCCH) channel estimation by using DMRSs respectively assigned to a plurality of slots. Such channel estimation may be referred to as joint channel estimation or may be referred to as another name such as cross-slot channel estimation.

In a plurality of slots, terminal 20 may transmit DMRSs respectively assigned to the plurality of slots, such that base station 10 can perform the joint channel estimation using the DMRSs.

Further, in the radio communication system, an enhanced function may be added to the feedback function from terminal 20 to base station 10. For example, an enhanced feedback function of a terminal for HARQ-ACK may be added.

Next, configurations of base station 10 and terminal 20 will be described. Note that the configurations of base station 10 and terminal 20 to be described below illustrate exemplary functions related to the present embodiment. Base station 10 and terminal 20 may have functions that are not illustrated. Further, functional classification and/or names of functional sections are/is not limited as long as the functions serve for executing operations according to the present embodiment.

### <Configuration of Base Station>

FIG. 14 is a block diagram illustrating an exemplary configuration of base station 10 according to the present embodiment. Base station 10 includes, for example, transmission section 101, reception section 102, and control section 103. Base station 10 communicates with terminal 20 (see FIG. 15) by radio.

Transmission section 101 transmits a downlink (DL) signal to terminal 20. For example, transmission section 101 transmits the DL signal under the control of control section 103.

The DL signal may include, for example, a downlink data signal and control information (e.g., Downlink Control Information (DCI)). The signal including the control information may be referred to as a control signal. Further, the DL signal may also include information (e.g., UL grant) indicating scheduling related to signal transmission of terminal 20. Furthermore, the DL signal may include higher layer control information (e.g., Radio Resource Control (RRC) control information). For example, higher layer signaling (e.g., RRC signaling or Media Access Control Control Element (MAC CE) may be regarded as exemplary DL signaling. Moreover, the DL signal may include a reference signal.

Channels used for DL signal transmission include, for example, data channels and control channels. For example, the data channels may include a Physical Downlink Shared Channel (PDSCH), and the control channels may include a Physical Downlink Control Channel (PDCCH). For example, base station 10 transmits control information to terminal using a PDCCH and transmits a downlink data signal using a PDSCH.

The reference signal included in the DL signal may include, for example, at least one of a Demodulation Reference Signal (DMRS), a Phase Tracking Reference Signal (PTRS), a Channel State Information-Reference Signal (CSI-RS), a Sounding Reference Signal (SRS), and a Positioning Reference Signal (PRS) for position information. For example, the reference signal such as the DMRS and the PTRS is used for demodulation of a downlink data signal and is transmitted using a PDSCH.

Reception section 102 receives an uplink (UL) signal transmitted from terminal 20. For example, reception section 102 receives the UL signal under the control of control section 103.

Control section 103 controls communication operations of base station 10 including transmission processing in transmission section 101 and reception processing in reception section 102.

For example, control section 103 acquires information such as data and control information from a higher layer and outputs the data and control information to transmission section 101. Further, control section 103 outputs data, control information, and/or the like received from reception section 102 to the higher layer.

For example, control section 103 allocates a resource (or channel) used for DL signal transmission and reception and/or a resource used for UL signal transmission and reception, based on the signal (e.g., data, control information and/or the like) received from terminal 20 and/or the data, control information, and/or the like acquired from the higher layer. Information on the allocated resource(s) may be included in control information to be transmitted to terminal 20.

Control section 103 configures a PUCCH resource as an exemplary resource allocation for UL signal transmission and reception. Information on the PUCCH configuration such as a PUCCH cell timing pattern (PUCCH configuration information) may be indicated to terminal 20 by RRC.

### <Configuration of Terminal>

FIG. 15 is a block diagram illustrating an exemplary configuration of terminal 20 according to the present embodiment. Terminal 20 includes, for example, reception section 201, transmission section 202, and control section 203. Terminal 20 communicates with base station 10 by radio, for example.

Reception section 201 receives a DL signal transmitted from base station 10. For example, reception section 201 receives the DL signal under the control of control section 203.

Transmission section 202 transmits a UL signal to base station 10. For example, transmission section 202 transmits the UL signal under the control of control section 203.

The UL signal may include, for example, an uplink data signal and control information (e.g., UCI). For example, the UL signal may include information on processing capability of terminal 20 (e.g., UE capability). Further, the UL signal may include a reference signal.

Channels used for UL signal transmission include, for example, data channels and control channels. For example, the data channel includes a Physical Uplink Shared Channel (PUSCH) and the control channel includes a Physical Uplink Control Channel (PUCCH). For example, terminal 20 receives control information from base station 10 using a PUCCH and transmits an uplink data signal using a PUSCH.

A reference signal included in the UL signal may include, for example, at least one of a DMRS, a PTRS, a CSI-RS, an SRS, and a PRS. For example, the reference signal such as the DMRS and the PTRS is used for demodulation of an uplink data signal and is transmitted using an uplink channel (e.g., PUSCH).

Control section 203 controls communication operations of terminal 20 including reception processing in reception section 201 and transmission processing in transmission section 202.

For example, control section 203 acquires information such as data and control information from a higher layer and outputs the data and control information to transmission section 202. Further, control section 203 outputs, for example, data, control information, and/or the like received from reception section 201 to the higher layer.

For example, control section 203 controls transmission of information to be fed back to base station 10. The information to be fed back to base station 10 may include, for example, a HARQ-ACK, Channel. State Information (CSI), or a Scheduling Request (SR). The information to be fed back to base station 10 may be included in UCI. The UCI is transmitted in a PUCCH resource.

Control section 203 configures a PUCCH resource based on the configuration information (e.g., configuration information such as a PUCCH cell timing pattern and/or DCI, which are/is indicated by RRC) received from base station 10. Control section 203 determines the PUCCH resource to be used for transmitting the information to be fed back to base station 10. Under the control of control section 203, transmission section 202 transmits the information to be fed back to base station 10 in the PUCCH resource determined by control section 203.

Note that the channels used for DL signal transmission and the channels used for UL signal transmission are not limited to the examples mentioned above. For example, the channels used for the DL signal transmission and the channels used for the UL signal transmission may include a Random Access Channel (RACH) and a Physical Broadcast Channel (PBCH). The RACH may be used for, for example, transmission of Downlink Control Information (DCI) including a Random Access Radio Network Temporary Identifier (RA-RNTI).

Reception section 201 may receive a DL control signal. The DL control signal is a signal that controls PUCCH repetition and/or SPS HARQ ACK deferring, for example, and may be a signal such as DCI, MAC CE, and/or RRC.

Control section 203 may control (determine) repetitive transmission of a UL control signal (e.g., PUCCH repetition) and deferring of transmission of the UL control signal (e.g., SPS HARQ-ACK deferring) based on the DL control signal received by reception section 203. The UL control signal may be, for example, a signal included in a PUCCH. The repetitive transmission may be slot-based repetitive transmission, sub-slot-based repetitive transmission, or dynamic repetitive transmission. More specifically, the repetitive transmission may be transmission of slot-based PUCCH repetitions, sub-slot-based PUCCH repetitions, or dynamic PUCCH repetitions.

Control section 203 need not assume that both the repetitive transmission of the UL control signal and the deferring of transmission of the UL control signal are performed (or configured/enabled) at the same time. Further, control section 203 may assume that both the repetitive transmission of the UL control signal and the deferring of transmission of the UL control signal are performed (or configured/enabled) at the same time.

When both the repetitive transmission of the UL control signal and the deferring of transmission of the UL control signal are enabled at the same time, control section 203 may control transmission of the UL control signal in accordance with a rule of at least one of the repetitive transmission of the UL control signal and the deferring of transmission of the UL control signal.

When both the repetitive transmission of the UL control signal and the deferring of transmission of the UL control signal are enabled at the same time, control section 203 may control transmission of the UL control signal in accordance with a rule of the repetitive transmission of the UL control signal modified based on the rule of the deferring of transmission of the UL control signal.

The above-described configuration allows terminal 20 to appropriately operate a transmission control of a UL control signal including configuration of a resource for transmitting the UL control signal in a radio system in which the repetitive transmission of the UL control signal and the deferring of transmission of the UL control signal are possible.

The present disclosure has been described thus far.

### <Hardware Configuration and the Like>

Note that, the block diagrams used to describe the above embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (e.g., via wires or wirelessly), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmission section,” “transmitting unit,” or “transmitter.” The methods for implementing the functions are not limited specifically as described above.

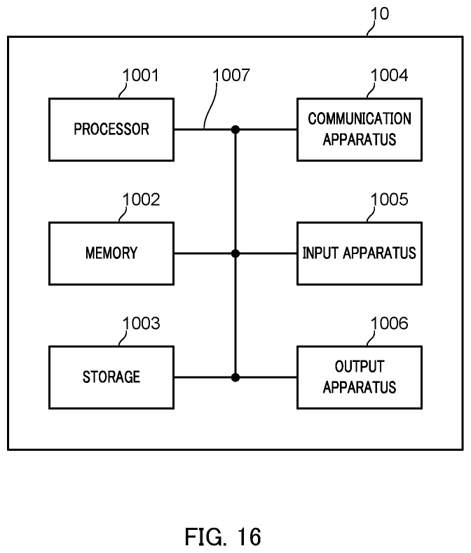

For example, the base station, the terminal, and the like according to an embodiment of the present disclosure may function as a computer that executes processing of a wireless communication method of the present disclosure. FIG. 16 illustrates an exemplary hardware configuration of the base station and the terminal according to the present embodiment. Base station 10 and terminal 20 described above may be each physically constituted as a computer apparatus including processor 1001, memory 1002, storage 1003, communication apparatus 1004, input apparatus 1005, output apparatus 1006, bus 1007, and the like.

Note that the term “apparatus” in the following description can be replaced with a circuit, a device, a unit, or the like. The hardware configurations of base station 10 and of terminal 20 may include one apparatus or a plurality of apparatuses illustrated in the drawings, or may not include part of the apparatuses.

The functions of base station 10 and terminal 20 are implemented by predetermined software (program) loaded into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a Central Processing Unit (CPU) including an interface with peripheral apparatuses, control apparatus, arithmetic apparatus, register, and the like. For example, control section 103 and control section 203 as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiment is used. For example, control section 203 of terminal 20 may be implemented by a control program stored in memory 1002 and operated by a control program operating in processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented by one or more chips. Note that, the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called a register, a cache, a main memory (main storage apparatus), or the like. Memory 1002 can save a program (program code), a software module, and the like that can be executed to carry out the wireless communication method according to an embodiment of the present disclosure.

Storage 1003 is a computer-readable recording medium and may be composed of, for example, at least one of an optical disk such as a CD-ROM (Compact Disc ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called an auxiliary storage apparatus. The storage medium as described above may be, for example, a database, a server or other appropriate media including at least one of memory 1002 and storage 1003.

Communication apparatus 1004 is hardware (transmission and reception device) for communication between computers through at least one of wired and wireless networks and is also called, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission section 101, reception section 102, reception section 201, and transmission section 202, and the like as described above may be realized by communication apparatus 1004.

Input apparatus 1005 is an input device (e.g., a keyboard, a mouse, a microphone, a switch, a button, or a sensor) that receives input from the outside. Output apparatus 1006 is an output device (e.g., a display, a speaker, or an LED lamp) which makes outputs to the outside. Note that input apparatus 1005 and output apparatus 1006 may be integrated (e.g., a touch panel).

The apparatuses, such as processor 1001, memory 1002 and the like, are connected by bus 1007 for communication of information. Bus 1007 may be configured using one bus or using buses different between each pair of the apparatuses.

Furthermore, base station 10 and terminal 20 may include hardware, such as a microprocessor, a digital signal processor (DSP), an ASIC (Application Specific Integrated Circuit), a PLD (Programmable Logic Device), and an FPGA (Field Programmable Gate Array), and the hardware may implement part or all of the functional blocks. For example, processor 1001 may be implemented using at least one of these pieces of hardware.

### <Notification and Signaling of Information>

The notification of information is not limited to the embodiment described in the present disclosure, and the information may be notified by another method. For example, the notification of information may be carried out by one or a combination of physical layer signaling (e.g., Downlink Control Information (DCI) and Uplink Control Information (UCI), higher layer signaling (e.g., Radio Resource Control (RRC) signaling, Medium Access Control (MAC) signaling, notification information (Master Information Block (MIB) and System Information Block (SIB))), and other signals. The RRC signaling may be called an RRC message and may be, for example, an RRC connection setup message, an RRC connection reconfiguration message, or the like.

### <Application System>

Each aspect/embodiment described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA 2000, UWB (Ultra Mobile Broadband), IEEE 802.11 (Wi-Fi (registered trademark)), IEEE 802.16 (WiMAX (registered trademark)), IEEE 802.20, UMB (Ultra-WideBand), Bluetooth (registered trademark), or other appropriate systems and a next-generation system extended based on the above systems. Additionally or alternatively, a combination of two or more of the systems (e.g., a combination of at least one of LTE and LTE-A and 5G) may be applied.

### <Processing Procedure and the Like>

The orders of the processing procedures, the sequences, the flow charts, and the like of the aspects and embodiment described in the present disclosure may be changed as long as there is no contradiction. For example, elements of various steps are presented in exemplary orders in the methods described in the present disclosure, and the methods are not limited to the presented specific orders.

### <Operation of Base Station>

Specific operations which are described in the present disclosure as being performed by the base station may sometimes be performed by an upper node depending on the situation. Various operations performed for communication with a terminal in a network constituted by one network node or a plurality of network nodes including a base station can be obviously performed by at least one of the base station and a network node other than the base station (examples include, but not limited to, MME and S-GW). Although there is one network node in addition to the base station in the case illustrated above, a plurality of other network nodes may be combined (for example, MME and S-GW).

### <Direction of Input and Output>

The information or the like (see the item of “Information and Signals”) can be output from a higher layer (or a lower layer) to a lower layer (or a higher layer). The information or the like may be input and output through a plurality of network nodes.

### <Handling of Input and Output Information and the Like>

The input and output information and the like may be saved in a specific place (e.g., memory) or may be managed using a management table. The input and output information and the like can be overwritten, updated, or additionally written. The output information and the like may be deleted. The input information and the like may be transmitted to another apparatus.

### <Determination Method>

The determination may be made based on a value expressed by one bit (0 or 1), based on a Boolean value (true or false), or based on comparison with a numerical value (e.g., comparison with a predetermined value).

### <Variations and the Like of Aspects>

The aspects and embodiment described in the present disclosure may be independently used, may be used in combination, or may be switched and used along the execution. Further, notification of predetermined information (e.g., notification indicating “it is X”) is not limited to explicit notification, and may be performed implicitly (e.g., by not notifying the predetermined information).

While the present disclosure has been described in detail, it is obvious to those skilled in the art that the present disclosure is not limited to the embodiment described in the present disclosure. Modifications and variations of the aspects of the present disclosure can be made without departing from the spirit and the scope of the present disclosure defined by the description of the appended claims. Therefore, the description in the present disclosure is intended for exemplary description and does not limit the present disclosure in any sense.

### <Software>

Regardless of whether the software is called software, firmware, middleware, a microcode, or a hardware description language or by another name, the software should be broadly interpreted to mean instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

### <Information and Signals>

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that, the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### <System and Network>

The terms “system” and “network” used in the present disclosure can be interchangeably used.

### <Names of Parameters and Channels>

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (e.g., PUCCH and PDCCH) and information elements can be identified by any suitable names, and various names allocated to these various channels and information elements are not limitative in any respect.

### <Base Station>

The terms “Base Station (BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” and “component carrier” may be used interchangeably in the present disclosure. The base station may be called a macro cell, a small cell, a femtocell, or a pico cell.

The base station can accommodate one cell or a plurality of (e.g., three) cells. When the base station accommodates a plurality of cells, the entire coverage area of the base station can be divided into a plurality of smaller areas, and each of the smaller areas can provide a communication service based on a base station subsystem (e.g., small base station for indoor (RRH: Remote Radio Head)). The term “cell” or “sector” denotes part or all of the coverage area of at least one of the base station and the base station subsystem that perform the communication service in the coverage.

### <Mobile Station>

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

### <Base Station/Mobile Station>

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the terminal. For example, the embodiment of the present disclosure may find application in a configuration that results from replacing communication between the base station and the terminal with communication between multiple terminals (such communication may, for example, be referred to as device-to-device (D2D), vehicle-to-everything (V2X), or the like). In this case, terminal 20 may be configured to have the functions that base station 10 described above has. The wordings “uplink” and “downlink” may be replaced with a corresponding wording for inter-terminal communication (e.g., “side”). For example, an uplink channel, a downlink channel, and the like may be replaced with a side channel.

Similarly, the terminal in the present disclosure may be replaced with the base station. In this case, base station 10 is configured to have the functions that terminal 20 described above has.

### <Meaning and Interpretation of Terms>

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### <Reference Signal>

The reference signal can also be abbreviated to an RS and may also be called a pilot depending on the applied standard.

### <Meaning of “Based On”>

The description “based on” used in the present disclosure does not mean “based only on,” unless otherwise specified. In other words, the description “based on” means both of “based only on” and “based at least on.”

### <“First” and “Second”>

Any reference to elements by using the terms “first,” “second,” and the like that are used in the present disclosure does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### <Means>

The “means” in the configuration of each apparatus described above may be replaced with “section,” “circuit,” “device,” or the like.

### <Open Form>

In a case where terms “include,” “including,” and their modifications are used in the present disclosure, these terms are intended to be inclusive like the term “comprising.” Further, the term “or” used in the present disclosure is not intended to be an exclusive or. Further, the term “or” used in the present disclosure is not intended to be an exclusive or.

<Time Units such as TTI, Frequency Units such as RB, and Radio Frame Configuration>

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology indicates, for example, at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini-slot, and the symbol indicate time units in transmitting signals. The radio frame, the subframe, the slot, the mini-slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (e.g., 1 to 13 symbols) that is shorter than 1 ms, or a duration that is longer than 1 ms. Note that, a unit that represents the TTI may be referred to as a slot, a mini-slot or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that can be used in each user terminal) on the basis of TTI to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (e.g., the number of symbols) to which the transport block, the code block, the codeword or the like is actually mapped may be shorter than the TTI.

Note that, in a case where one slot or one mini-slot is referred to as the TTI, one or more TTIs (that is, one or more slots or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that, the long TTI (e.g., the usual TTI, the subframe, or the like) may be replaced with the TTI that has a time length which exceeds 1 ms, and the short TTI (e.g., the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini-slot, one subframe, or one TTI. One TTI and one subframe may be constituted by one resource block or a plurality of resource blocks.

Note that, one or more RBs may be referred to as a Physical Resource Block (PRB: Physical RB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common RBs (common resource blocks) for certain numerology in a certain carrier. Here, the common RBs may be identified by RB indices that use a common reference point of the carrier as a reference. The PRB may be defined by a certain BWP and may be numbered within the BWP.

The BWP may include a BWP for UL (UL BWP) and a BWP for DL (DL BWP). An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that is included in the radio frame, the number of slots per subframe or radio frame, the number of mini-slots that is included within the slot, the numbers of symbols and RBs that are included in the slot or the mini-slot, the number of subcarriers that is included in the RB, the number of symbols within the TTI, the symbol length, the Cyclic Prefix (CP) length, and the like can be changed in various ways.

### <Maximum Transmit Power>

The “maximum transmit power” described in the present disclosure may mean a maximum value of the transmit power, the nominal UE maximum transmit power, or the rated UE maximum transmit power.

### <Article>

In a case where articles, such as “a”, “an”, and “the” in English, for example, are added in the present disclosure by translation, nouns following these articles may have the same meaning as used in the plural.

### <“Different”>

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### INDUSTRIAL APPLICABILITY

An aspect of the present disclosure is useful for radio communication systems.

### REFERENCE SIGNS LIST

10 Base station
20 Terminal
101, 202 Transmission section
102, 201 Reception section
103, 203 Control section

1.-6. (canceled)

7. A terminal, comprising:
a reception section that receives a downlink shared channel, the downlink shared channel being based on semi-persistent scheduling (SPS);
a transmission section that transmits an acknowledgement response to the downlink shared channel through an uplink control channel; and
a control section that configures deferring of transmission of the acknowledgement response, wherein
the control section expects, when configuring the deferring of transmission of the acknowledgement response, that repetition of a resource for the uplink control channel is not configured.

8. The terminal according to claim 7, wherein
the reception section receives configuration information on a resource of the uplink control channel, and
the control section expects, when configuring the deferring of transmission of the acknowledgement response, that repetition of the uplink control channel is not configured in the configuration information.

9. A base station, comprising:
a transmission section that transmits a downlink shared channel, the downlink shared channel being based on semi-persistent scheduling (SPS);
a reception section that receives an acknowledgement response to the downlink shared channel through an uplink control channel; and
a control section that configures deferring of transmission of the acknowledgement response, wherein
the control section does not configure repetition of a resource for the uplink control channel when configuring the deferring of transmission of the acknowledgement response.

10. A radio communication method, comprising:
receiving, by a terminal, a downlink shared channel that is based on semi-persistent scheduling (SPS);
transmitting, by the terminal, an acknowledgement response to the downlink shared channel through an uplink control channel;
configuring, by the terminal, deferring of transmission of the acknowledgement response; and
expecting, by the terminal, when configuring the deferring of transmission of the acknowledgement response, that repetition of a resource for the uplink control channel is not configured.

11. A radio communication system, comprising:
a terminal that receives a downlink shared channel, the downlink shared channel being based on semi-persistent scheduling (SPS), transmits an acknowledgement response to the downlink shared channel through an uplink control channel, and configures deferring of transmission of the acknowledgement response; and
a base station that transmits the downlink shared channel, receives the acknowledgement response through the uplink control channel, and configures deferring of transmission of the acknowledgement response, wherein
the terminal expects, when configuring the deferring of transmission of the acknowledgement response, that repetition of a resource for the uplink control channel is not configured.
